(19) United States
(12) Patent Application Publication
(10) Pub. No.: US 2022/0145613 A1
(43) Pub. Date: May 12, 2022

(54) RECONFIGURABLE MOBILE BUSINESS UNIT HAVING MODULARIZED UTILITIES AND CONFIGURABLE SYSTEM OF MOBILE BUSINESS UNITS FOR DEPLOYMENT AT A SITE

(71) Applicant: REEF GLOBAL IP LLC, Miami, FL (US)

(72) Inventor: Kevin W. Haynes, Parkland, FL (US)

(21) Appl. No.: 17/520,297

(22) Filed: Nov. 5, 2021

Related U.S. Application Data
(60) Provisional application No. 63/110,675, filed on Nov. 6, 2020.
(60) Provisional application No. 63/123,004, filed on Dec. 9, 2020.

(51) Int. Cl. E04B 1/343; B60P 3/025; B60P 3/36; F24C 15/30

(52) U.S. Cl. CPC E04B 1/34352; F24C 15/30; B60P 3/36; B60P 3/025

(57) ABSTRACT

Mobile business units featuring modularized utilities for plug and play of business unit equipment provide a reconfigurable and scalable system of mobile business units for a variety of businesses including, for example, a mobile kitchen or “ghost kitchen”, classroom or office space, medical facilities, insurance or disaster relief facilities, fabrication units, pharmacies, grocery-to-go units, mobile repair garages, and mobile broadcasting centers. The mobile business units can be stacked, positioned side by side, positioned end to end, and interconnected in various systems using modular interconnection units. The modularized utilities enable quick reconfiguration and plug and play of business unit equipment so each mobile business unit can be rapidly reconfigured.

### CROSS REFERENCE TO RELATED APPLICATIONS

The present application claims the benefit of U.S. Provisional Patent Application No. 63/110,675 filed Nov. 6, 2020 and U.S. Provisional Patent Application 63/123,004 filed Dec. 9, 2020, the disclosure of which is incorporated by reference herein in its entirety.

### TECHNICAL FIELD

This invention relates to a mobile business unit and more particularly to a reconfigurable mobile business unit as well as a configurable system of mobile business units for deployment at a site.

### BACKGROUND ART

The advent of technology has dramatically changed food service and the retail landscape in general. Online ordering and home delivery of food, as well as online shopping has opened doors for the customers to get what they want, when they want, from the convenience of their homes. For restaurants, while delivery to customers is easier than ever via GrubHub and other food delivery services, food is still prepared at costly and fixed location brick and mortar businesses. For online ordering of products, delivery to the purchasers home is a continuing challenge for retailers to control cost and expedite delivery

Of course, for both restaurants and ecommerce retailers, the closer proximity to the end customer the more efficient delivery becomes in terms of time and cost. Therefore, reducing the so-called “last mile delivery”, which is the flow of goods from the nearest transport hub to their final destination, is of critical importance.

Locating warehouses in urban centers is expensive and impractical due to space constraints, so delivery trucks are still used to deliver customer products over significant distances and through traffic. Food trucks and off-premises kitchens, also known “ghost kitchens”, have been used to bring food preparation closer to the end customer, but they have not yet been designed and deployed in a truly effective manner.

Other businesses such as mobile health care and testing, mobile optometry fabrication, mobile pharmacy, mobile insurance and disaster relief, mobile broadcasting, and mobile offices would also benefit by being moved closer to the end customer. While mobile businesses are expanding, the cost of scaling, integrating, and reconfiguring mobile businesses remains high and there still exists a need for a better and more cost effective solution.

### SUMMARY OF THE EMBODIMENTS

It is an object of the invention to provide rapid and easy reconfiguration of mobile business units which may be deployed in close proximity to end users, which are easily reconfigurable to meet various application and customer requirements.

It is a further object of the invention to provide scalable mobile business units that can be configured in a system of mobile business units for deployment at a site.

The technology can be further summarized in the following features:

In one aspect, a reconfigurable mobile business unit having modularized utilities is provided. The reconfigurable mobile business unit includes a main frame having an interior floor surface; and a container frame having a plurality of interior wall surfaces mounted on and along a circumference of the interior floor surface of the main frame, each of the plurality of wall surfaces extending substantially perpendicular from the interior floor surface; the container frame also having an interior ceiling surface mounted on the plurality of interior wall surfaces and being substantially parallel to the interior floor surface; wherein the interior floor surface, the interior wall surfaces, and the interior ceiling surface together define an interior volume of the mobile business unit. In some embodiments, the reconfigurable mobile business unit includes a plurality of equipment locations positioned at regular intervals about the circumference of the interior floor surface of the main frame, each of the equipment locations having a utility bundle installed in one of an interior wall surface or the interior floor surface and being accessible in the interior volume of the mobile business unit to enable installation of a piece of business unit equipment at any one of the plurality of equipment locations.

In some embodiments, the reconfigurable mobile business unit can be wherein each utility bundle includes at least two utilities selected from the following utility types: electrical, water, drainage, propane, or gas.

In some embodiments, the reconfigurable mobile business unit includes wherein the mobile business unit is configured as one or more of the following: a mobile kitchen, a mobile health care unit, a classroom, an office space, a disaster relief facility, a fabrication unit, a pharmacy, a grocery-to-go unit, a mobile repair garage, a broadcasting center, or combinations thereof.

In some embodiments, the reconfigurable mobile business unit can be wherein the mobile business unit is configured as a kitchen and one or more of the following equipment types may be installed at the plurality of equipment locations: a refrigerator, a microwave, an oven, a freezer, an electric fryer, a stove top, an electric griddle, an induction stove, an extraction hood, a dishwasher, a hand sink, a mop sink, a water pump, a fire suppression system, an A/C unit, a heat and condensation pump.

In some embodiments, the reconfigurable mobile business unit can be wherein the mobile business unit is configured for medical use and one or more of the following equipment types may be installed at the plurality of equipment locations: a patient data terminal, a surgery bed, an autoclave, an instrument table, an x-ray machine, a triage/intake station, and a utility sink.

In some embodiments, the reconfigurable mobile business unit can be wherein the mobile business unit is configured as an office and one or more of the following equipment types may be installed at the plurality of equipment locations: a desk, a filing cabinet, partitions or cubicles, private meeting rooms, a drink/coffee machine, and a printer.

In some embodiments, the reconfigurable mobile business unit can be wherein the mobile business unit is configured as grocery store and one or more of the following equipment types may be installed at the plurality of equipment locations: a refrigerator unit, a freezer unit, water distribution for a produce display unit with water distribution, a scale, a scanner, and a check out station.

In some embodiments, the reconfigurable mobile business unit can further include one or more sensors to monitor one or more of the following: air quality, power usage, utilities status and usage, temperature, smoke, and carbon monoxide.

In one aspect, a configurable system of mobile business units for deployment at a site is provided. The configurable system of mobile business units for deployment at a site includes a first mobile business unit disposed at a first location at the site; a second mobile business unit disposed at a second location at the site; and a modular interconnection unit physically in contact with an exterior surface of the first mobile business unit and physically in contact with an exterior surface of the second mobile business unit; the modular interconnection unit configured to interconnect an interior of the first mobile business unit to an interior of the second mobile business unit.

In some embodiments, the configurable system of mobile business units can be wherein the modular interconnection unit includes an interior region, a first opening in communication with the first mobile business unit and the interior region of the modular interconnection unit, and a second opening in communication with the second mobile business unit and the interior region of the modular interconnection unit.

In some embodiments, the configurable system of mobile business units can be wherein the modular interconnection unit is one of triangular or rectangular in shape.

In some embodiments, the configurable system of mobile business units can be wherein the first mobile business unit and the second mobile business unit include a lifting system to elevate the first and second mobile business units; and wherein the modular interconnection unit includes a lifting system to elevate the modular interconnection unit to be aligned with the first and second mobile business units. In some embodiments, each lifting system can include a plurality of piston mechanisms.

In some embodiments, the configurable system of mobile business units can be wherein each of the first mobile business and the second mobile business unit include: a main frame having an interior floor surface; a container frame having a plurality of interior wall surfaces mounted on and along a circumference of the interior floor surface of the main frame, each of the plurality of wall surfaces extending substantially perpendicular from the interior floor surface; the container frame also having an interior ceiling surface mounted on the plurality of interior wall surfaces and being substantially parallel to the interior floor surface; wherein the interior floor surface, the interior wall surfaces, and the interior ceiling surface together define an interior volume of the mobile business unit; a plurality of equipment locations positioned at regular intervals about the circumference of the interior floor surface of the main frame, each of the equipment locations having a utility bundle installed in one of an interior wall surface or the interior floor surface and being accessible in the interior volume of the mobile business unit; each utility bundle including at least electrical, water, and drainage utilities to enable installation of a piece of business unit equipment at any one of the plurality of equipment locations.

In some embodiments, the configurable system of mobile business units can be wherein each of the first mobile business and the second mobile business unit may be configured as one of the following: a mobile kitchen, a mobile health care unit, a classroom, an office space, a disaster relief facility, a fabrication unit, a pharmacy, a grocery-to-go unit, a mobile repair garage, a broadcasting center, or combinations thereof.

### BRIEF DESCRIPTION OF THE DRAWINGS

Embodiments of the present disclosure will now be described, by way of example only, with reference to the attached Figures, wherein:

FIG. 1 shows a perspective view of a mobile business unit in accordance with various embodiments.

FIG. 2A shows a perspective view of a mobile container frame, a removable hitch assembly, and a removable axle assembly in accordance with various embodiments.

FIG. 2B shows a side view of a first side of a mobile container frame, a removable hitch assembly, and a removable axle assembly in accordance with various embodiments.

FIG. 2C shows a side view of a second side of a mobile container frame, a removable hitch assembly, and a removable axle assembly in accordance with various embodiments.

FIG. 3A shows a perspective view of a removable axle assembly including an axle frame, axles, and tires on rims in accordance with various embodiments.

FIG. 3B shows a top view of a removable axle assembly including an axle frame, axles, and tires on rims in accordance with various embodiments.

FIG. 4A shows a perspective view of a removable axle assembly detached from a base frame of a mobile business unit in accordance with various embodiments.

FIG. 4B shows a perspective view of a removable axle assembly rotated under a mobile business unit in accordance with various embodiments.

FIG. 4C shows a perspective view of a removable axle assembly rolled out from under a mobile business unit in accordance with various embodiments.

FIG. 5A shows a perspective view of a retractable hitch assembly in accordance with various embodiments.

FIG. 5B shows a perspective view of a retractable hitch assembly and a tongue receiver in accordance with various embodiments.

FIG. 6 shows a perspective view of a floor including floor panels on the main frame of FIG. 2B, a floor panel at the front of the main frame of FIG. 2B, and a floor panel partially over the hitch frame of FIG. 2B in accordance with various embodiments.

FIG. 7 shows a rear view of a composite impermeable flooring structure having integrated baseboards in a mobile business unit in accordance with various embodiments.

FIG. 8 shows a cross-sectional side view of an interior of a first side of the mobile business unit of FIG. 1, configured as a ghost kitchen, in accordance with various embodiments.

FIG. 9 shows a cross-sectional side view of an interior of a second side of the mobile business unit of FIG. 1, configured as a ghost kitchen, in accordance with various embodiments.

FIG. 10 shows an illustration of example parts of a mobile container including examples of integrated systems and support systems in accordance with various embodiments.

FIG. 11 shows an example schematic of an electrical utility system for a mobile container in accordance with various embodiments.

FIG. 12 shows an example schematic of a fresh water utility system for a mobile container in accordance with various embodiments.

FIG. 13 shows an example schematic of a gray/black water utility system for a mobile container in accordance with various embodiments.

FIG. 14 shows an example schematic of a propane utility system for a mobile container in accordance with various embodiments.

FIG. 15 shows examples of configurations and layouts of mobile business units in parking spaces in accordance with various embodiments.

FIG. 16A shows an example of a side by side configuration of two mobile business crossing over parking spaces in accordance with various embodiments.

FIG. 16B shows an example of a side by side configuration of two mobile business units positioned lengthwise in parking spaces in accordance with various embodiments.

FIG. 17A shows a top view of a configurable system of mobile business units including a modular interconnection unit in accordance with various embodiments.

FIG. 17B shows a side view of a modular interconnection unit in accordance with various embodiments.

FIG. 17C shows a rear view of a modular interconnection unit in accordance with various embodiments.

FIG. 17D shows a front view of a modular interconnection unit in accordance with various embodiments.

FIG. 18A shows a perspective view of a configurable system of mobile business units including a modular interconnection unit in accordance with various embodiments.

FIG. 18B shows a top view of a configurable system of mobile business units including a modular interconnection unit in accordance with various embodiments.

FIG. 18C shows a bottom view of a configurable system of mobile business units including a modular interconnection unit in accordance with various embodiments.

FIG. 18D shows a perspective interior view of a configurable system of mobile business units including a modular interconnection unit in accordance with various embodiments.

FIG. 19A shows a side view and a front view of a mobile container in accordance with various embodiments.

FIG. 19B shows a side view and a front view of a mobile container in accordance with various embodiments.

FIG. 19C show examples of layouts of mobile containers in parking spaces in accordance with various embodiments.

FIG. 20 shows a side view of a configurable system of mobile business units including external infrastructure in accordance with various embodiments.

FIG. 21A shows a perspective view of mobile business unit configured to provide mobile healthcare in accordance with various embodiments.

FIG. 21B shows a perspective view of a configurable system of mobile containers including two mobile containers combined side by side to provide mobile healthcare in accordance with various embodiments.

FIG. 22A shows a perspective view of a configurable system of mobile business containers including two mobile containers positioned end to end in accordance with various embodiments.

FIG. 22B shows a side view of a system of mobile business containers including two mobile containers positioned end to end to provide proximity space in accordance with various embodiments.

FIG. 23 shows an example of smart phone monitoring of real-time power usage and historical water usage for a mobile container in accordance with various embodiments.

FIG. 24 shows an example of smart air quality monitoring for a mobile container in accordance with various embodiments.

### DETAILED DESCRIPTION OF SPECIFIC EMBODIMENTS

The disclosure and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments, as the skilled artisan would recognize, even if not explicitly stated herein.

Descriptions of well-known components and processing techniques may be omitted to not unnecessarily obscure the embodiments of the disclosure. The examples used herein are intended merely to facilitate an understanding of ways in which the disclosure may be practiced and to further enable those of skill in the art to practice the embodiments of the disclosure. Accordingly, the examples and embodiments herein should not be construed as limiting the scope of the disclosure. Moreover, it is noted that like reference numerals represent similar parts throughout the several views of the drawings.

In accordance with various embodiments, a mobile business unit is provided. The mobile business unit can be deployed to a location by towing to the location. In some embodiments, mobile business units can be configured as non-trailered containers which may be transported by flat bed or containerized trucks and dropped off at the desired site. Two or more mobile business units can be deployed to the location and configured as a system of mobile business units, for example, by proximity or by utilizing a modular interconnection unit. After deployment to the location, a mobile business unit can be fixed to operate as a stationary unit. In the case of the trailered mobile business unit it can be transformed to a stationary business unit by utilizing a lifting system, which can be automated, and rolling a removable axle assembly with tires out from under the mobile business unit. The stationary business unit can be readily converted back to a mobile configuration when needed. The lifting system can be an automated lift that can include or be a part of an auto leveling system, which can be a pneumatic auto leveling system or an auto-leveling hydraulic leveling system. The auto leveling system can provide auto leveling to adjust to the grade of the specific location.

The preferred embodiments of a mobile business unit including a mobile container and a system of mobile business units are depicted as mobile or ghost kitchens, as mobile health care and testing units, grocery-to-go units, and mobile offices herein, but it should be understood that this is only exemplary and that the concepts described herein are equally applicable to any applications requiring scalable reconfigurable space. In some embodiments, mobile containers can be interconnected and configured to provide a variety of business services in a single location.

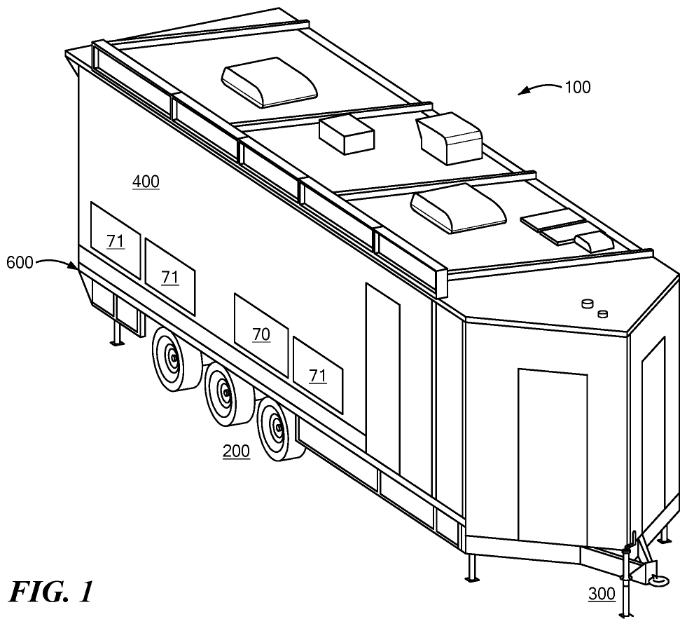

Referring now to FIG. 1, a mobile business unit 100 is provided. The mobile business unit 100 includes a mobile container 400 positioned on top of a trailer assembly 600, which may include a removable axle assembly 200. The removable axle assembly can generally include an axle frame having tires and rims. The mobile business unit can also include a removable/retractable hitch assembly 300 including a hitch frame and hitch connector. The mobile container 400 can include a delivery locker driver access door 70 and service access panels 71.

The advantages of a mobile business unit can be enhanced by the capability to provide a stationary business unit. After deploying a mobile business unit, a stationary business unit can further establish a business service or brand in underserved neighborhoods. Conversion to a stationary business unit can provide the advantages of brick and mortar without the lack of mobility. For example, some locations may have zoning restrictions prohibiting mobile units with wheels and hitches, other locations can have restrictions for the outward appearance of a business unit, and the permanence of a superior business location can be enhanced by a stationary business unit. The mobile business unit disclosed herein can quickly be converted to a stationary business unit. After deployment, the mobile container can be lifted, and the removable axle assembly can be rolled out from underneath. The removable axle assembly can be rapidly removed and re-deployed for use with a different mobile business unit. And, if the deployed mobile business unit needs to be re-deployed to a new location the removable axle assembly can be reinstalled and the mobile business unit can be moved to the new location.

### Removable Axle Assembly

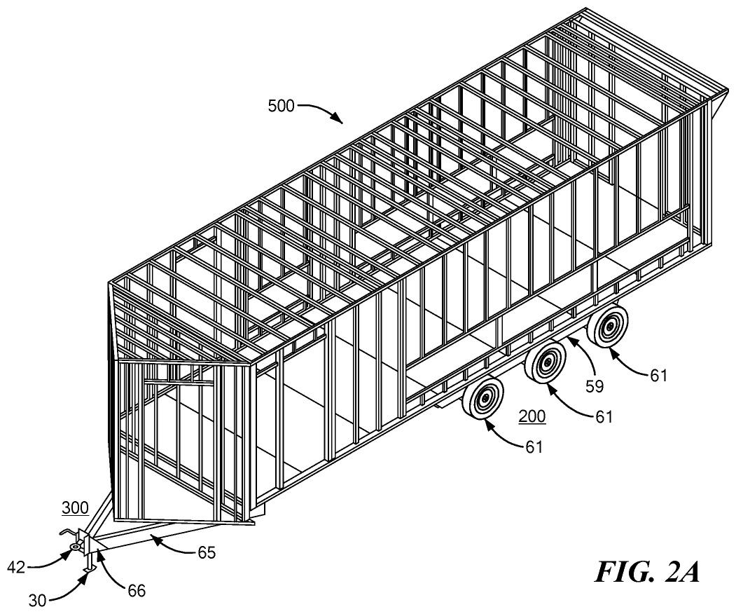

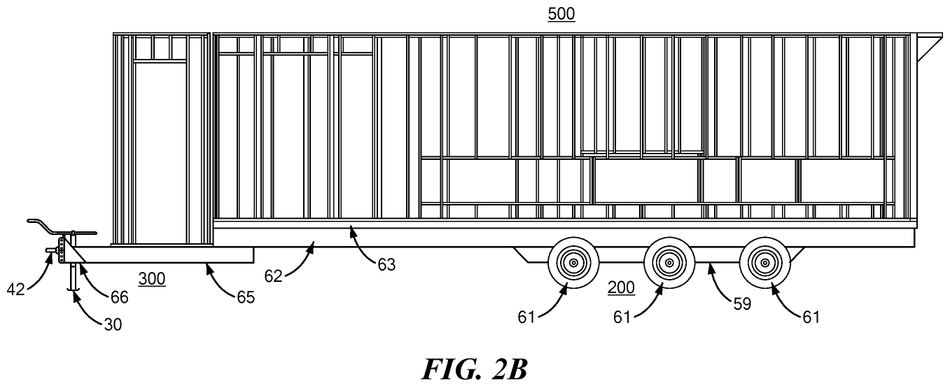

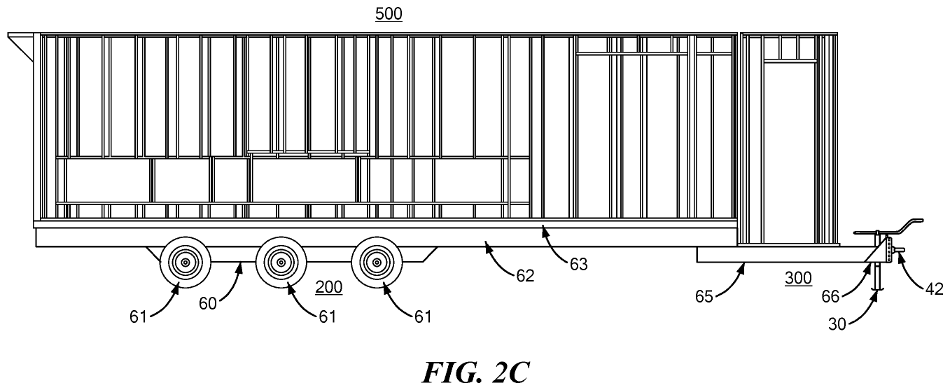

While any suitable towable mobile business unit may be used in connection with the scalable mobile business units and rapid mobile reconfiguration concepts described herein, a preferred towable mobile container 400 is depicted in FIG. 1 to include a mobile container frame 500, which is depicted in the perspective view of FIG. 2A. Referring to FIG. 2A, there is depicted a mobile container frame 500 mounted on removable axle assembly 200, which includes tires and rims 61 and an axle frame with a first longitudinal frame member 59. The side views depicted in FIG. 2B and FIG. 2C show the mobile container frame 500 is affixed to a main frame 63, which is further affixed to a base frame 62. A fixture assembly is configured to removably interconnect the axle frame of the removable axle assembly 200 to the base frame 62. By releasing the fixture assembly, the removable axle assembly 200 can be removed by lifting the mobile unit with the base frame 62 and rolling the removable axle assembly 200 out from underneath. Referring to the removable hitch assembly 300 depicted in FIG. 2B, the hitch frame 65 of the removable hitch assembly 300 can be removed from the base frame 62.

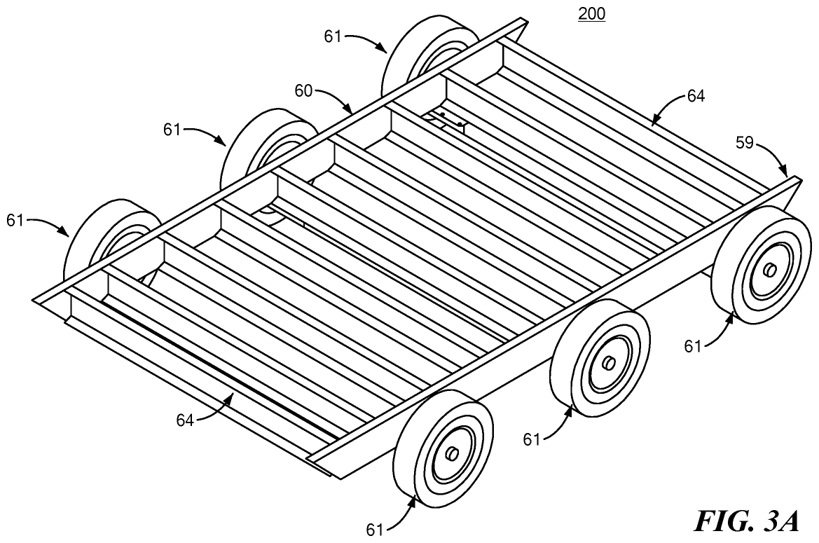

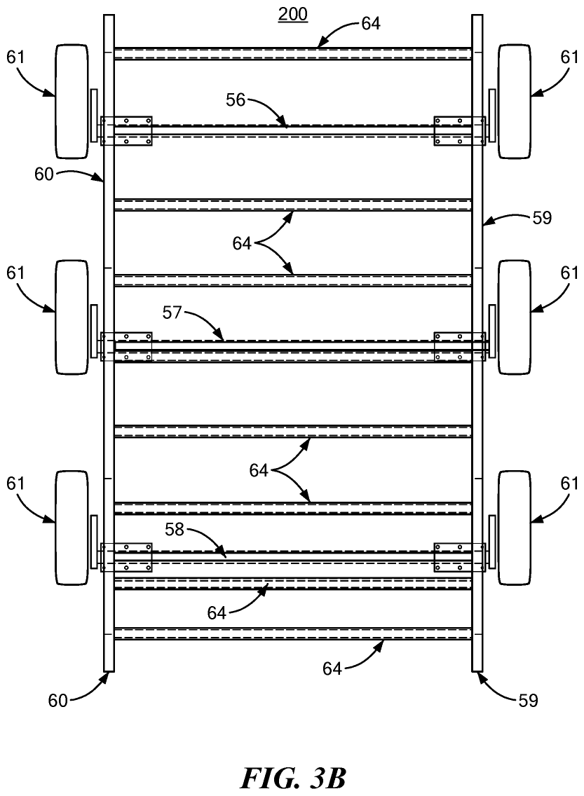

A removable axle assembly 200, in accordance with various embodiments, is depicted in the perspective view of FIG. 3A and in the top view of FIG. 3B. The removable axle assembly 200 has an axle frame with a first longitudinal frame member 59, a second longitudinal frame member 60, and cross support frame members 64. Referring to FIG. 3B, a back axle assembly 56, a mid-axle assembly 57, and a front axle assembly 58 are affixed to the axle frame. The removable axle assembly 200 can include a fixture assembly configured to removably connect to the base frame of the mobile container. The tires with rims 61 can include any size tires and rims that provide a suitable height for the removable axle assembly 200. For example, 12 inch, 13 inch, 14 inch, 15 inch, 16 inch, 17 inch, 18 inch, or 19 inch rims can be utilized with tires of a suitable width. The number of wheel, tires, and axles is not limited, and the example illustrated in FIG. 3A and FIG. 3B can be changed for different configurations. For example, the number of tires, wheels, and axles can be increased for heavier mobile businesses units. As shown, the removable axle assembly includes straight axles, but it will be apparent based on this disclosure that the axles may include shocks and springs. The tires and rims 61 can include steering capabilities integrated with the axles, for example, to aid steering the mobile business unit around corners in tight locations.

The longitudinal frame members can include a first longitudinal frame member 59 extending substantially in a longitudinal direction and a second longitudinal frame member 60 extending substantially in a longitudinal direction of the mobile business unit. Any number of additional longitudinal frame members can be added, for example, to provide more strength or to provide for rugged locations. The cross support frame members 64 can include a plurality of cross support frame members interconnected between the first and second longitudinal frame members. The configuration of the axle frame can be any configuration suitable to affix the tires with rims and to transport the mobile business unit. The frame members can be configured, for example, with additional longitudinal frame members, with cross support frame members intersecting or with a box frame surrounding the axle frame. The cross support frame members 64 and the longitudinal frame members 59 and 60 can each be fabricated, for example, from a lightweight metal, alloy, carbon fiber, or polymer material.

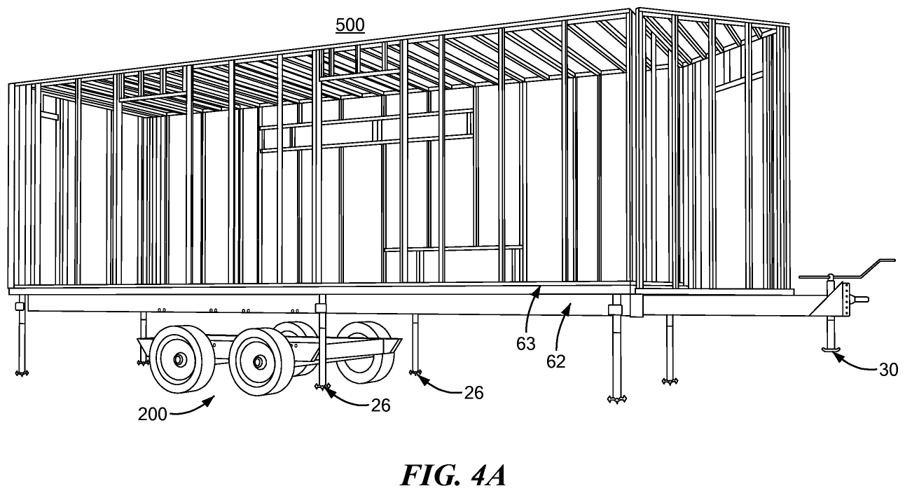

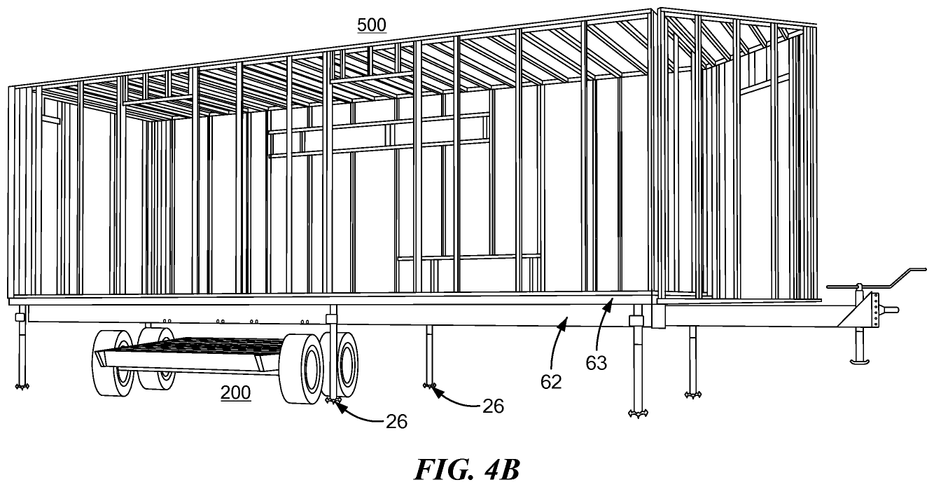

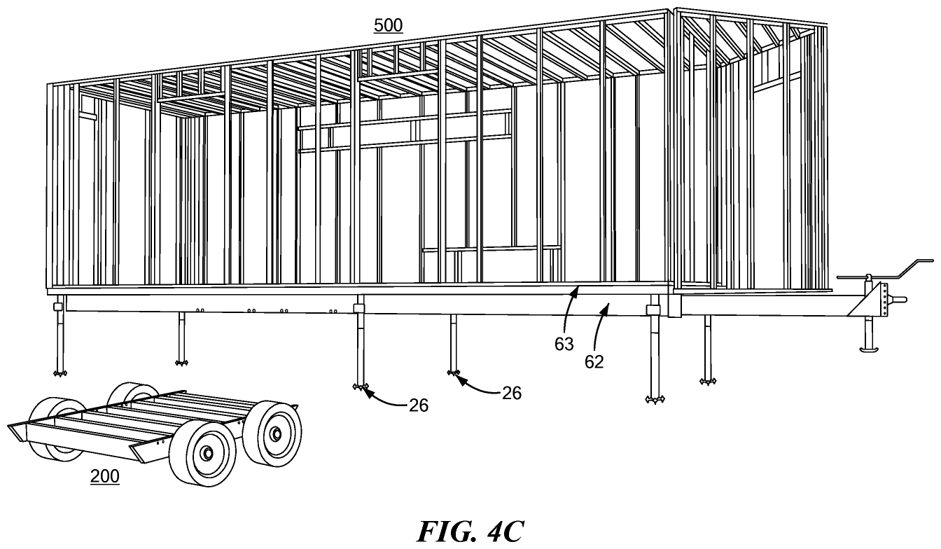

An example of removal of the removable axle assembly 200 from under the base frame 62, in accordance with various embodiments, is depicted in FIGS. 4A-4C. According to some embodiments, referring to the view of FIG. 4A, the lifting system 26 can be utilized to lift the mobile business unit. The lifting system can include a piston mechanism positioned at each corner of a frame of the mobile business unit. The lifting system 26 can be a manual or motorized mechanical system, a pneumatic system, or an automatic hydraulic leveling system, for example, a Bigfoot© automatic hydraulic leveling system (thebigfootleveler.com). An auto-leveling hydraulic leveling system can provide two-way hydraulic pistons or cylinders which can provide an automated lift for raising the mobile business unit and for removal or installation of items under the mobile business unit. A fixture assembly can be released to detach the removable axle assembly 200 from the base frame 62. The fixture assembly can include, for example, electromagnetic fasteners, automated mechanical fasteners, hand fasteners, or fasteners removable with hand tools (e.g., pliers and a wrench), which can be released before or after lifting the mobile container.

Referring to FIG. 4B, the lifting system 26 is depicted supporting the mobile business unit. The base frame 62 is detached from the removable axle assembly 200. The removable axle assembly 200 has been turned after it has been released from the base frame 62. The removable axle assembly can be removed without turning the removable axle assembly, for example, by rolling the removable axle assembly towards the back of the mobile business unit until the removable axle assembly is out from under the mobile business unit. The removable axle assembly 200 can be rolled out from under the mobile business unit in the example depicted in FIG. 4C.

While removal of the axle assembly can provide some benefits of a stationary business unit, removal of the axle assembly 200 is optional and depends on the business needs. Removal of the axle assembly 200 can, for example, provide a theft deterrent when the mobile business unit is parked in a location. The removable axle assembly can be repositioned underneath the mobile container and reattached to the base frame to convert a stationary business unit to a mobile business unit.

In some embodiments, the stationary business unit can also include a removable hitch assembly and optional removal of the towing hitch. An example removable hitch assembly 300, according to various embodiments, is depicted in FIG. 2C. The removable hitch assembly 300 includes a hitch frame 65 and a hitch connector 66. The hitch frame 65 can be removed from the base frame 62 depicted in FIG. 2C. After deployment to a location, the towing hitch 42 and the tongue jack 30 can be removed from the hitch connector 66 using, for example, pliers and a wrench. In some stationary business unit configurations, the hitch frame 65 can be removed, for example, to take up less space in the location, or to prevent passersby or vehicles from colliding with the hitch connector 66 or the hitch frame 65. The floor and space directly above the hitch frame can optionally be removed with the hitch frame. The towing hitch 42 can be a pintle towing hitch or other suitable towing hitch. The tongue jack 30 can be a 10,000 pound (4536 kilogram) tongue jack or other suitable capacity tongue jack, depending on the size of the mobile business unit. For example, the tongue jack 30 can be a manually operated or turned tongue jack, a motorized tongue jack, an automated tongue jack, a self-leveling tongue jack, a remote controlled tongue jack, a hydraulic tongue jack, or a combination thereof.

According to some embodiments, a removable hitch assembly 300 can be removed to provide an exterior appearance of a stationary business unit. When removed, the removable hitch assembly can shorten the overall length of a mobile business unit. In some embodiments, the hitch frame 65 can provide an A-frame mechanism or tongue receiver at an apex of the hitch frame. The removable hitch frame can be removed to shorten the total exterior length of a business unit provided herein. The shortening, for example, can shorten the total exterior length of a business unit to fit within a few parking spaces, three parking spaces, two parking spaces, one parking space, or within a closed garage.

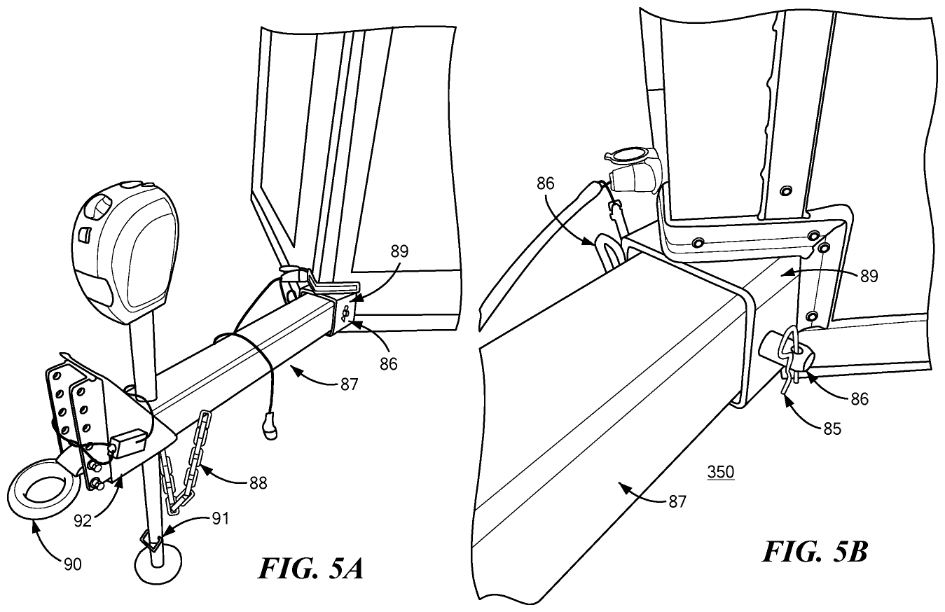

In some embodiments, a retractable hitch assembly 350 including a tongue 87 can be provided as shown in FIGS. 5A and 5B. A distal end of the tongue 87 can be secured in a tongue receiver 89. For example, as shown in FIG. 5B, a lock pin 86 can secure the tongue 87 in the tongue receiver 89. At a proximal end of the tongue 87, a hitch connector 92 can be provided with a towing hitch 90, a tongue jack 91, and safety chains 88. The hitch connector 92, the towing hitch 90, and the tongue jack 91 can be, for example, substantially similar to the hitch connector 66, towing hitch 42 and tongue jack 30 described above with reference to FIG. 2C. The hitch connector 92, towing hitch 90, tongue jack 91, and safety chains 88 can be removed from the tongue 87, for example, by utilizing hand tools. The tongue 87 can be extended to a fully extended position during towing of a mobile business unit. The tongue 87 can be retracted by removing lock pin 86 and pushing the tongue 87 into the tongue receiver 89. Although described and shown herein as retractable into the receiver, it will be apparent in view of this disclosure that, in some embodiments, the tongue 87 of the retractable hitch assembly 350 can also be configured to be optionally extractable from the tongue receiver 89 for providing removable hitch functionality.

FIG. 5B depicts a perspective view of the tongue 87 and the tongue receiver 89. In some embodiments, a cotter pin 85 can secure a lock pin 86. The cotter pin 85 can be removed from the lock pin 86 and the lock pin 86 can be removed from the tongue receiver 89 and the tongue 87. After removal of the lock pin 86, the tongue 87 can be pushed towards the tongue receiver 89 until the tongue is flush with the tongue receiver.

### Composite Impermeable Flooring Structure Having Integrated Baseboards

While any suitable flooring structure and materials may be used in connection with the mobile business units described herein, a preferred structure may be a composite impermeable flooring structure having integrated baseboards which may be provided in an interior portion of the mobile business unit. The composite impermeable flooring structure having integrated baseboards can be configured for rapid washing or sterilization of the floor and baseboards. The integrated baseboards can provide a transition joint connecting an interior floor with the lower portion of an interior wall. For example, the transition joint can provide washing or sterilization of a portion of the interior wall, along with the baseboard and floor, without leakage. An exterior surface of the composite impermeable flooring structure having integrated baseboards can provide a non-slip surface for walking or standing. For example, the non-slip surface can be impermeable, water proof, grease and oil resistant, chemical resistant, heat resistant, fireproof, and wear resistant.

A composite impermeable flooring structure having integrated baseboards can be positioned above a main frame of the mobile business unit or above a floor on the main frame. The main frame 63 can be affixed to the base frame 62 as depicted in FIG. 2C. A main frame 63, according to an aspect of this disclosure, is also depicted in FIG. 4C. The main frame 63 is positioned on top of the base frame 62 (FIG. 2C). The mainframe can be connected to the base frame 62 by, for example, permanent welds, adhesive, fasteners, or other means. The main frame 63 is affixed to the mobile container 400 (FIG. 1) of the mobile business unit. Referring to FIG. 4C, a mobile container frame 500 can be mounted along a circumference of the main frame 63, wherein an interior surface of the main frame and one or more interior surfaces of the container frame can define an interior volume of the mobile business unit.

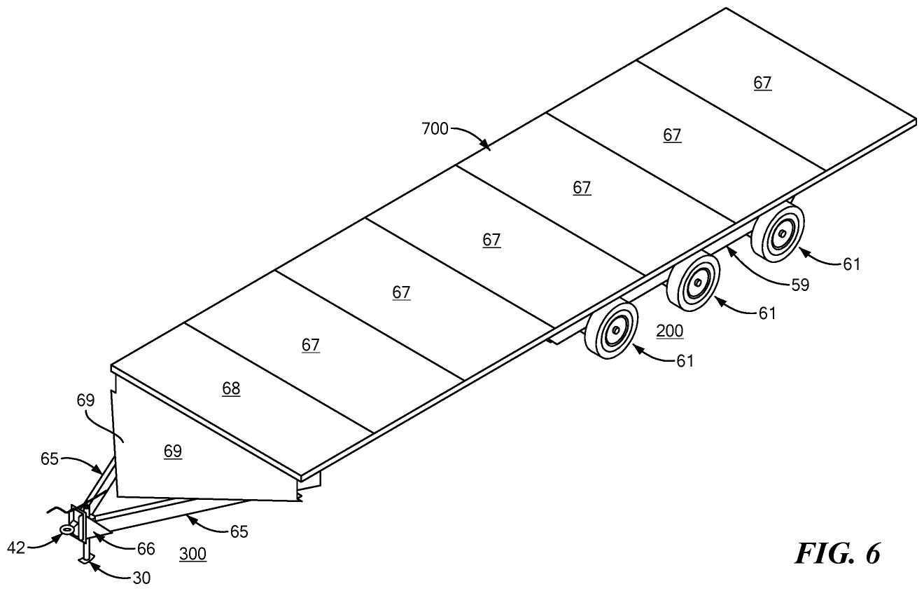

According to some embodiments, referring now to FIG. 6, a floor 700 is affixed to the main frame 63, which is shown in FIG. 2C and in FIG. 4C. In some embodiments, the floor 700 can include a plurality of floor panels 67 and one or more floor panels with a different size 68. In FIG. 6, a floor panel 68 with a different size is shown at the front of the main frame. A floor panel 69 with a different shape is positioned partially covering the hitch frame 65. The floor panel 69 can be removed with the removable hitch assembly 300. The floor 700 can be a stainless steel floor that can be provided in a plurality of stainless steel panels, or the floor can be provided as a single floor unit that is cut to the size and shape of a main frame 63. A composite impermeable flooring structure having integrated baseboards can be directly affixed to the main frame 63. A composite impermeable flooring structure having integrated baseboards can be integrated with the floor 700 or the plurality of floor panels depicted in FIG. 6 and positioned above the main frame 63 of FIG. 4C. In some embodiments, a composite impermeable flooring structure having integrated baseboards can be positioned above the plurality of floor panels depicted in FIG. 6, for example, with one or more layers between the floor panels depicted in FIG. 6 and the composite impermeable flooring structure having integrated baseboards.

The floor 700 including, for example, floor panels 67, 68, and 69 depicted in FIG. 6 can be composite flooring panels including a foundation layer for contacting the interior surface of the main frame, a resilient or energy absorbent layer disposed over the foundation layer, and a support layer disposed over the resilient or energy absorbent layer. The foundation layer can include, for example, plywood, wood composite, plastic, metal, or a combination thereof. The foundation layer can be attached to the main frame, for example, by screwing, bolting, welding, or a combination thereof. Each composite flooring panel can include an interior layer, which may include a paint layer, an adhesive layer, or a combination thereof, interposed between the foundation layer and the resilient or energy absorbent layer. The composite flooring panels can be joined together by an adhesive, a weld, an impermeable coating, or a combination thereof. In some embodiments, the floor 700 can include a composite impermeable flooring structure.

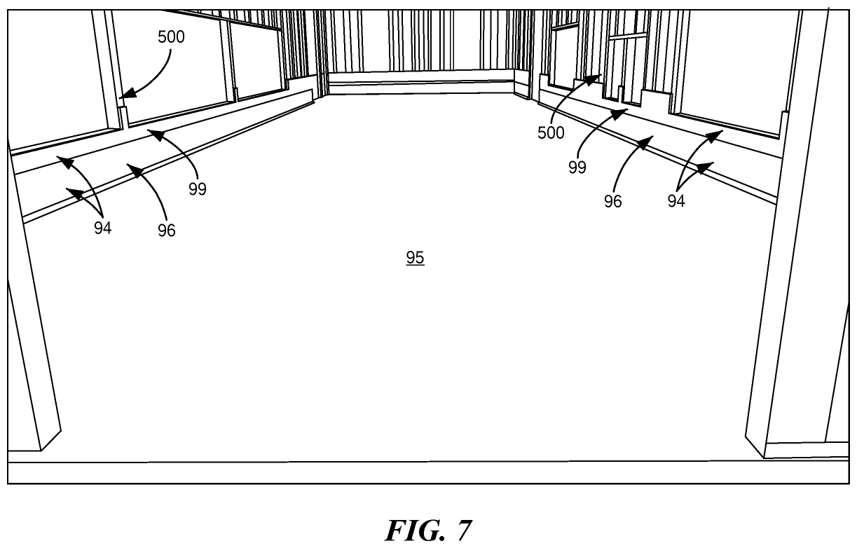

FIG. 7 illustrates a composite impermeable flooring structure 95 having composite baseboards 94 in accordance with various embodiments. Each composite baseboard 94 can include a wall layer 99 and one or more layers 96 disposed over the wall layer. The wall layer 99 can contact the interior of the mobile container frame 500 of the mobile business unit. The one or more layers 96, for example, can include an interior layer disposed over the wall layer 99, a resilient or energy absorbing layer, a support layer, an impermeable layer, or a combination thereof. An impermeable coating can extend over the composite impermeable flooring structure 95 and the composite baseboard 94 to form an interior surface of the composite impermeable flooring structure having integrated baseboards. The wall layer 99, for example, can include plywood, wood composite, metal or alloy, plastic, or a combination thereof.

In some embodiments, a transition joint can be provided between the composite baseboard 94 and the composite impermeable flooring structure 95. The transition joint can include, for example, a right angle, a fillet, a chamfer, or a combination thereof. The transition joint can include the same materials, layers, or composites as the composite impermeable flooring structure 95. The transition joint may include a separate material, for example, a metal or an alloy weld, a polymer, a silicone, an epoxy, or a combination of materials. The transition joint can include a chamfer between the composite baseboard 94 and the composite impermeable flooring structure 95. The chamfer can provide a bevel for a transitional edge between the composite baseboard 94 and the composite, impermeable flooring structure 95. The transition joint can include a fillet or a rounding curvature between the composite baseboard 94 and the composite impermeable flooring structure 95. The fillet can include a concave curvature. A concave curvature can form a tub-like surface including the transition joint, the composite baseboard 94, and the composite impermeable flooring structure 95. For example, a curvature at the transition joint can allow for liquid to drain down the composite baseboard 94 and onto the composite impermeable flooring structure 95.

A composite impermeable flooring structure having integrated baseboards can include a floor material. The floor material can include one or more layers, for example, an impermeable layer, a resilient or energy absorbing layer, a support layer, a support layer, a paint/adhesive layer, or combinations thereof. In this way, the additional layers can be added for added chemical resistance, electrical resistance, heat or cold resistance, heavier loading requirements, or vibration dampening, for example. The support layer can include metal or plastic or any other suitable rigid or semi-rigid impermeable material. The support layer can be constructed from steel diamond plate. The impermeable layer can include polyurea, polyurethane polyurea/polyurethane hybrids, rubber, an epoxy, Ultra High Molecular Weight Polyethylene (UHMW-PE), or combinations thereof. For example, the impermeable layer can be a bed liner non slip coating. In some embodiments, a texture can be included with the impermeable layer or directly underneath on the support layer in order to promote additional non-slip functionality (e.g., where the impermeable layer is textured or impregnated with grit-forming particles or the support layer is diamond plate).

Under the support layer can be a resilient or energy absorbing layer. The resilient or energy absorbing layer can be an open-cell foam, a closed-cell foam, a gel-infused foam, a gel pad, rubber, rubber foam, or combinations thereof. At bottom is a foundation layer for engagement with the main frame. The foundation layer can include, for example, plywood, wood composite, plastic, or metal. In some embodiments, the composite floor can also include a paint and/or adhesive layer interposed between the foundation layer and the resilient or energy absorbing layer. In some embodiments the paint/adhesive layer can include, for example, latex paint, oil paint, epoxy, acrylates, acrylic latex, polyvinyl acetate, or combinations thereof.

It will be apparent in view of this disclosure that, in accordance with various embodiments, the wall layer 99 and other layers 96 of the composite baseboard material can, individually or as a whole, be similar to the layers of the composite floor material. Generally speaking, the impermeable layer should be a single layer extending over the entire composite floor and the integrated baseboards.

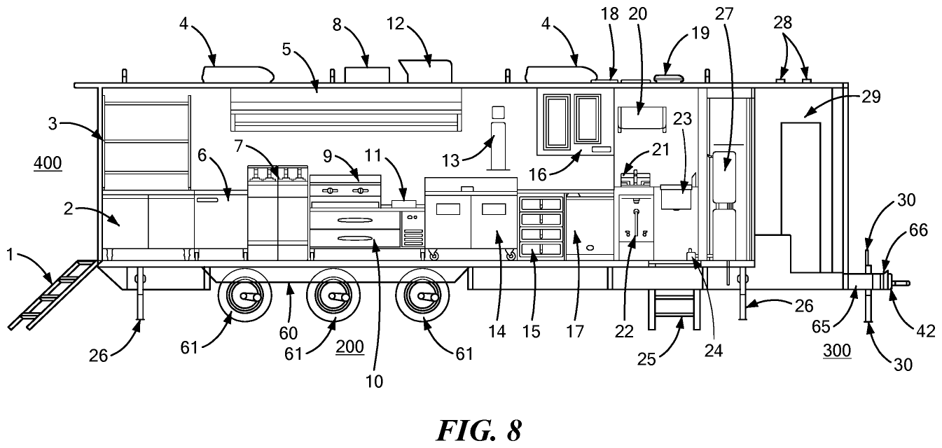

The composite impermeable flooring structure 95 illustrated in FIG. 7 can be applied to the exterior of the mobile business unit, for example, on the foldup staircase 1 and on the foldup staircase 25 depicted in FIG. 8. The composite impermeable flooring structure can be atop the floor, baseboards, and a portion of the sidewalls in the mobile business unit.

A non-slip surface can be at least on a portion of the composite impermeable flooring structure having integrated baseboards. In some embodiments, the non-slip surface can be any surface having a measure of slip resistance. For example, in some embodiments the non-slip surface can have a static coefficient of friction (SCOF) greater than 0.1 as measured when the surface is clean and dry. In general, SCOF defines the ratio between the force required to put an object in motion and the downward force exerted on it from gravity. A SCOF close to zero refers to slippery surfaces whereas a SCOF near 1 refers to high friction surfaces. In some embodiments, the SCOF of the non-slip surface can be, for example, greater than 0.5, greater than 0.6, or greater than 0.8.

### Modularized Utilities for Reconfiguration/Plug and Play Equipment

Mobile business units can be constructed and configured for use in connection with a wide array of mobile applications. Each mobile business unit may need to be configured for the desired business applications including, for example, kitchens, classroom or office space, medical facilities, insurance or disaster relief facilities, fabrication units, pharmacies, grocery-to-go units, mobile repair garages, broadcasting centers, or combinations thereof. For each particular business application different types of business unit equipment (e.g. refrigerators, ovens, computer equipment, medical devices etc.) will be required and the location and layout of such required equipment may differ depending on customer requirements. Designing and outfitting mobile business units for various applications and custom needs can be a demanding and time consuming effort.

The mobile business units described and disclosed herein can be rapidly and easily configured and reconfigured for use in connection with a wide array of mobile applications and an array custom layouts and designs based on user requirements. Before or after deployment to a location, the mobile business unit can be configured for a particular business application. In some embodiments, a mobile business unit includes a plurality of equipment locations positioned at regular intervals about the circumference of the interior floor surface of the main frame. Each of the equipment locations may include a utility bundle installed in one of an interior wall surface or the interior floor surface. Each utility bundle may enables plug and play installation of business unit equipment at each equipment location. The utility bundles may include various types of utilities, including but not limited to electric, water, drainage, gas, and network cabling. Each mobile container may be rapidly reconfigured as needed by installing a piece of business unit equipment at any one of the plurality of equipment locations.

Any piece of business unit equipment needed for an application can be easily installed in any one of the equipment locations each including a utilities bundle. The plurality of equipment locations enables reconfiguration of a mobile container by enabling detachment of unneeded business unit equipment and attachment of necessary business unit equipment.

An example business unit application is a ghost or mobile kitchen and one exemplary configuration and layout is depicted in FIG. 8. As shown in cross-sectional view in FIG. 8, an interior of a first side of a ghost kitchen can include equipment locations. The equipment locations can include utility bundles (i.e. connections for two or more types of utilities) for plug and play of business unit equipment (not shown). The utility bundles can be provided at regular intervals about the interior of the mobile business unit. Such equipment can include, for example, an under-counter refrigerator freezer 2, a refrigerator 6, a dishwasher 17, a hand sink 21, a mop sink 22, a 3-compartment sink 23, a water pump 24, a fire suppression system 13, an electric fryer 7, an electric griddle 9, and an induction stove 11. In some embodiments, the interior of the business unit can be modularized with plug and play storage, table space, and shelving including a metro wire rack 3, a 60″ chef base 10, a 48″ prep table 14, equipment storage drawers 15, a metro smart wall and drying rack 20, and an above head storage cabinet 16. An extraction hood 5, can be moved, for example, if the induction stove 11 is moved. Plug and play ventilation features include A/C units with heat and condensation pump 4, a makeup air fan 8, an extraction fan 12, and a bathroom fan 19. The ventilation features can be affixed to an exterior side of the mobile business unit instead of to the roof, for example, to accommodate a low ceiling of an interior parking garage.

According to some embodiments, water can be distributed from fresh water tanks 27, power can be distributed from solar panels 18, data can be transferred from GPS and LTE antennas 28, and data can be monitored from an IT box 29.

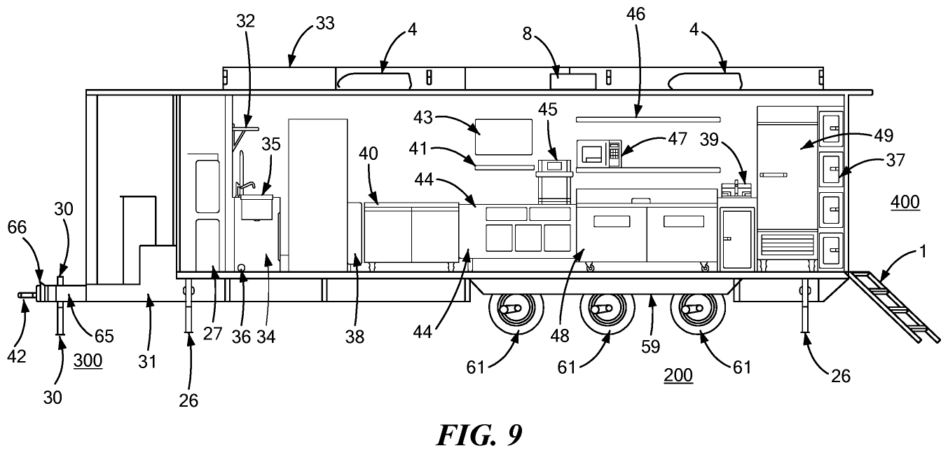

As shown in cross-sectional view in FIG. 9, the interior of a second side of the ghost kitchen can include business unit equipment installed in various positions, in accordance with some embodiments. The equipment locations include utility bundles that can be attached to the required business unit equipment. Such equipment can include an IT box 31, roof mounted LED advertising screens 33, a water heater 34, a 3-compartment sink 35, a water pump 36, an under counter refrigerator 40, an order display monitor 43, a turbo chef oven 45, a microwave 47, a hand sink 39, an upright freezer 49, and delivery lockers 44. The interior of the business unit can be modularized with plug and play storage, table space, and shelving including a metro smart wall shelf 32, a 72″ preparation table 48, wall mount shelves 46, a trash bin 38, a wall mounted shelf 41, and employee lockers 37.

Still referring to FIG. 9, in some embodiments, the order display monitor 43 can be controlled by software and a microprocessor with RAM that is integrated with the delivery lockers 44 and that instructs chefs to place specific delivery orders into specific delivery lockers for each end customer. The delivery lockers 44 can be connected to the delivery locker driver access door 70 (see FIG. 1), which can be a plurality of doors 70. Each delivery locker 44 can contain contents for a single end customer. Each delivery locker driver access door 70 can provide a delivery driver secured access to a product for a single delivery end customer. For example, a delivery driver can be directed to a specific delivery locker driver access door 70 by a software application on the delivery driver's smartphone or computer. The software application, for example, can unlock the specific delivery locker driver access door by a lock that is actuated by software. The software can be cloud software integrating orders, supplies, preparation, delivery, distance, and time, for example, that prioritizes preparation of orders for the chefs so that the most distant customers' orders are prioritized, taking into account traffic and distance and data gathered from the internet. At any position on the mobile business unit, a customer service window or counter (not shown) can optionally be provided, for example, to provide direct contact with outdoor customers, delivery drivers, vendors, or employees.

Although the delivery lockers 44 are illustrated and described herein as being configured for placement of a single delivery order for a single end customer, it will be apparent in view of this disclosure that, in some embodiments, multiple discrete orders intended for multiple end customers can be aggregated into a single delivery locker 44. For example, such aggregation can be used where multiple orders are to be delivered by the same delivery driver in the same delivery run.

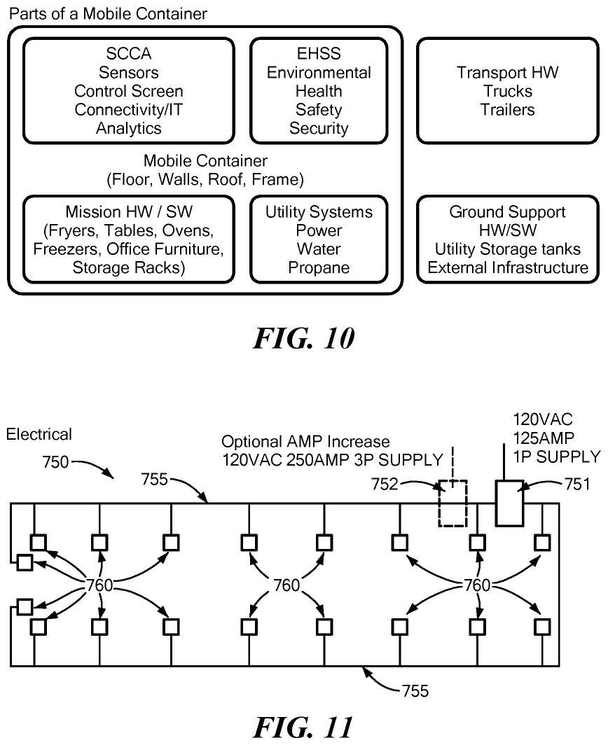

According to some aspects of this disclosure, referring now to FIG. 10, example parts of a mobile container including examples of integrated systems and support systems are illustrated. A mobile container includes a floor, walls, a roof, and a frame. The mobile container can include utility systems. The utility systems can provide utilities at equipment locations including utility bundles. Smart business unit equipment can include sensors, control screen, connectivity/IT, and analytics (SCCA). Examples of sensors are air quality, power and water utilities monitoring, and temperature sensors, all of which can connect to the internet. Examples of analytics are monitoring of power, water, and gas consumption over time, and product inventory monitoring. Environmental, health, safety, and security (EHSS) equipment can be provided, for example, smoke sensors, carbon monoxide sensors, and security cameras.

The mission hardware/software (HW/SW) can include business unit equipment to configure the mobile container and software to control and monitor the business unit equipment. For example, if a mobile container is configured for medical use, the mobile medical container can have patient data terminals, surgery beds, autoclaves, instrument tables, x-ray machines, triage/intake stations, and utility sinks. A mobile office container can have desks, filing cabinets, partitions or cubicles, private meeting rooms, a drink/coffee machine, and printers. Business unit equipment for a mobile grocery can, for example, include accessible refrigerator units, freezer units, water distribution for produce display units, scales, and scanners. A grocery-to-go can have large refrigerated and frozen sections, security cameras, and a check out station.

In some embodiments, a mobile container can be configured with utilities to operate and communicate with the internet while in transport from one location to another. For example, a mobile container may continuously send smart temperature data from coolers while in transport. A mobile container may contain smart sensors to monitor air quality while in transport through various locations.

Still referring to FIG. 10, in some embodiments, the mobile container can include supporting Transport hardware (HW), for example, trucks and trailers. Several mobile containers can be shipped to a location at once for a configurable scalable system of mobile business units, as will be described below. The mobile container can include Ground Support hardware/software (HW/SW), for example, utility storage tanks and external infrastructure (e.g., awnings, side coverings, accessibility ramps, walkways, modularized benches, guard railings).

The utility systems (FIG. 10) included with the mobile container can provide utilities at equipment locations including utility bundles installed at regular intervals in one of an interior wall surface or an interior floor surface about the circumference of the interior floor surface of the main frame of the mobile container. According to some aspects of this disclosure, FIG. 11 depicts a schematic of an electrical utility system 750 component to provide power to a plurality of junction boxes 760 at regular intervals about the circumference of the mobile container as one part of utility bundles dispersed throughout the mobile business unit. The location of each of the junction boxes constitutes a location where various pieces of equipment may be installed (i.e. an “equipment location”). As described below, additional types of utilitie may be included at each equipment location, the utilities together forming a utility bundle, which makes for easy installation of various types of equipment quickly and easily at each equipment location.

Continuing to refer to FIG. 11, wiring 755, which can be provided in conduits, connects each junction box to a single phase panel 751. A three phase panel 752 can be installed, for example, to provide higher amperage. In some embodiments, the wiring can provide power from solar panels, from a backup power supply, or both. Each junction box 760 can be installed in one of an interior wall surface or an interior floor surface and can be accessible in the interior volume of the mobile business unit

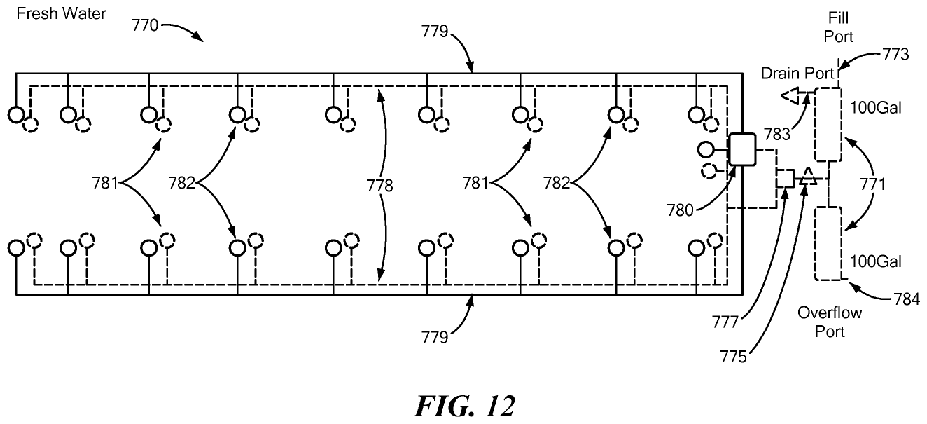

According to some aspects of this disclosure, FIG. 12 depicts a schematic of a fresh water utility system 770 component, including a plurality of cold water taps 781 and hot water taps 782 at regular intervals (coinciding with the utility junction boxes 760, FIG. 11) about an interior wall surface or an interior floor surface about the circumference of the interior floor surface of the main frame of the mobile container. Cold water lines 778 connect the cold water taps to a water pump 777, valve 775, and fresh water tanks 771. Hot water lines 779 connect the hot water taps 782 to a water heater 780. The fresh water tanks 771 include a drain port 783, a fill port 773, and an overflow port 784. The water heater 780 can be a tankless water heater. The taps 781/782 are included with the electrical outlets as part of the utility bundles dispersed at regular intervals throughout the mobile business unit.

In some embodiments, a plurality of tankless water heaters can be provided in proximity to each cold water tap to provide the hot water taps. According to some aspects, tankless water heaters may be included at regular intervals about the circumference of a mobile container and can be utilized for proximity heating of cold water. Electrical power for the tankless water heaters, for example, can be provided by the electrical utility system 750.

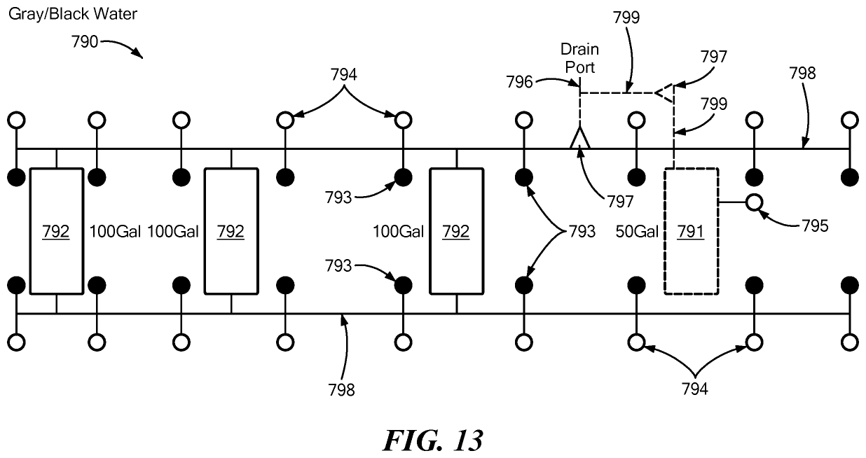

Referring to FIG. 13, a schematic of a gray/black water utility system 790 depicts a plurality of gray water drain ports 794 at regular intervals (coinciding with the utility junction boxes 760, FIG. 11, and the cold water taps 781 and hot water taps 782, FIG. 12) about an interior wall surface or an interior floor surface about the circumference of the interior floor surface of the main frame of the mobile container. Gray water lines 798 connect the gray water drain ports to gray water storage tanks 792. Black water lines 799 feed a black water drain 795 (e.g., a toilet drain) to black water storage 791. A drain port 796 and drain valves 797 can be utilized to drain the gray water storage 792 or black water storage 791.

In some embodiments, each utility bundle can include at least a junction box 760 with power (FIG. 11), cold water 781 (FIG. 12), and gray water drain port 794 (FIG. 13) utilities to enable installation of a piece of business unit equipment at any one of the plurality of equipment locations, which are spaced at regular intervals about the circumference of the mobile container. In some embodiments, each utility bundle can include at least a junction box 760 with power (FIG. 11), cold water 781 and hot water 782 (FIG. 12), and a gray water drain port 794 (FIG. 13). In some embodiments, for reconfiguration of business unit equipment, the equipment locations can be configured to provide one or more utility bundles including electrical power, water, gas (e.g., propane, natural gas, carbon dioxide), removal of water waste, exhaust gas release, or a combination thereof. Electrical power can be provided in three phase, single phase, DC, or in any suitable phase or voltage.

For example, the utility bundles at regular intervals about an interior wall surface or an interior floor surface about the circumference of the interior floor surface of the main frame of the mobile container can be at regular intervals of 2 feet, 3 feet, 4 feet, 5 feet, or 6 feet. In some embodiments, the regular intervals can be determined based on the utility requirements of a specific mobile container.

The utility bundles can be standardized for safety and can be for example, water proof, gas and vapor proof, heat resistant, tamper resistant, and easy to clean or sterilize. A utility bundle can include an aperture with an opening and a cover that remains closed when the utility bundle is not in use. The aperture, the cover, or both can include a seal. For example, the cover can be water proof, spark proof, grease and oil proof, tamper proof, and wear resistant. In some embodiments, the utility bundles can be provided within a recess in a floor, a wall or an interior surface of the mobile container. The recess can be configured so when a utility bundle is not in use, the wall or surface provides a flat surface with the cover of the utility bundle flush with the wall surface.

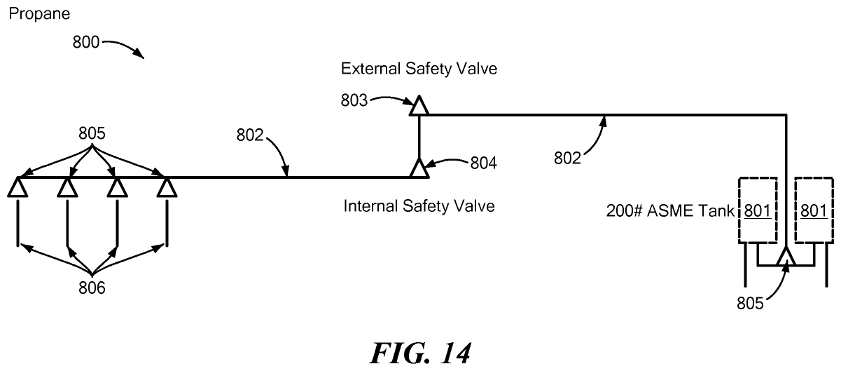

According to an aspect of this disclosure, FIG. 14 depicts a propane utility system 800 component to provide utility bundles including, for example, natural gas, propane or liquid propane, carbon dioxide, or pneumatic pressure. Unlike the power water, and drainage utilities depicted in FIGS. 11-13, which are included at each equipment location dispersed at regular intervals around the interior of the mobile business unit, the gas utililities are included at only a subset of locations, in this example four locations. Alternatively, each equipment location and hence each utility bundle can optionally include a gas utility connection 806 connected to a service valve 805. Propane or gas lines 802 connect to an internal safety valve 804 and an external safety valve 803. Propane gas tanks 801 can provide gas source to the utility system.

It will be apparent in view of this disclosure that, in accordance with various embodiments, the propane utility system 800 component can provide an additional utility connection to one or more utility bundles. For example, a mobile container can be configured as a mobile repair garage with compressed air provided at each equipment location and at each utility bundle. Generally speaking, the additional utility connection should be provided at an equipment location with a gas utility connection 806.

In some embodiments, each equipment location including a utility bundle can include one or more sensors operative to detect, for example, a voltage surge/failure, a water leak, a gas pressure variance, or a type of business unit equipment attached to the utility bundle. The electrical utility system 750 and the components thereof can include smart sensors to monitor real time power usage and to transmit the usage data through the internet for visual access through, for example, a smartphone. The fresh water utility system 770 can include sensors to monitor water usage and to similarly transmit the water usage data through the internet.

In some embodiments, one or more utility systems can be operational while a mobile container is in transport or shipping. For example, the electrical utility system 750 can be operational to provide power for temperature control and monitoring of refrigerated goods while a mobile container is in transport. In another example, a dishwasher can operate to provide clean dishes while a mobile container is in transport. It should be noted that each equipment location/utility bundle need not have a uniform set of utilities and the utilities can be dispersed as needed throughout the mobile business unit, creating different types of utility bundles throughout the mobile business unit.

### Example Configurable System of Mobile Business Units Embodiment

Two or more mobile business units may be configured as a system of mobile business units for deployment at a site. According to some aspects, two or more mobile business units can be shipped or towed to a location and can be positioned or stacked in any configuration and connected, for example, by physical contact, by one or more modular interconnection units, or by physically combining the two or more mobile containers. The size of each mobile container can be varied to provide incremental business expansion capability. Larger mobile containers can be interconnected with smaller mobile containers in any configuration so as to enable incremental size scalability. The mobile business units can be individually configured for various applications and deployed with other mobile business units configured for the same or complimentary applications. It should be noted that the mobile business units may be of any type, including the above-described reconfigurable mobile business units. The mobile business units may be deployed to parking locations, such as parking garages or parking lots such that they are in proximity to customers living proximate to such parking locations.

By co-locating or interconnecting mobile business units, a business can incrementally grow and expand while retaining mobile capability. For example, the business challenges of location constraints and spatial scales can be addressed. According to some aspects, the business growth provided by the technology herein can avoid unused space while providing a sustainable and green growth model. A configurable system of mobile business units can grow to fit a specific size or shape of available space. In some embodiments, positioning two or more mobile business units in proximity can provide sustainable growth. External infrastructure can be added to or affixed to configurable systems of mobile business units, as the business grows and becomes established.

The mobile business units may be configured as a system of mobile business units for any application(s) including but not limited to ghost kitchens, mobile health care and testing units, classroom or office space, medical facilities, insurance or disaster relief facilities, fabrication units, pharmacies, grocery-to-go units, mobile repair garages, broadcasting centers, or combinations thereof. However, the mobile business unit including a mobile container and a system of mobile business units can be applied, for example, anytime mobile space is required for any application.

According to some embodiments, a mobile business unit can be shortened by a function of a removable hitch assembly 300 (FIG. 2C) or a retractable hitch assembly 350 (FIG. 5A). The mobile business unit 100 illustrated in FIG. 1 can have, for example, exterior measurements from back to the front towing hitch of about 32 feet (9.75 meters) long by about 8.5 feet (2.59 meters) wide from side to side. Two standard parking spaces placed end to end can measure 36 feet (10.97 meters) long and 9 feet (2.74 meters wide). Two standard parking spaces positioned end to end can provide a location for this example. The mobile business unit is not limited by size and can be constructed for larger (e.g., five parking spaces) or smaller locations (e.g., less than one parking space). In general, a compact parking space is understood in the parking industry to be 8 feet (2.44 meters) wide and 16 feet (4.88 meters) long and a standard parking space is generally understood to be 9 feet (2.74 meters) wide and 18 feet (5.49 meters) long.

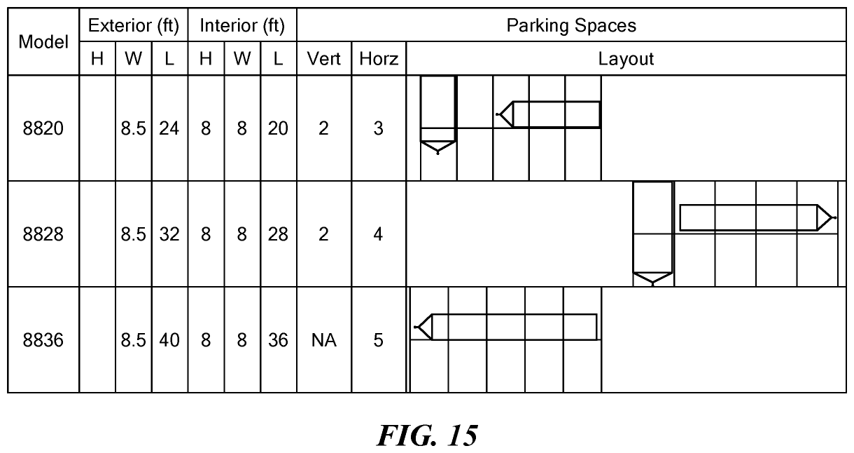

According to some aspects of this disclosure, FIG. 15 depicts example exterior dimensions of mobile business units including example configurations and layouts of mobile business units in parking spaces. At the top of FIG. 15, a front to side layout of two 24 feet (exterior dimension) long mobile business units is depicted. At the center of FIG. 15, a back to side layout of two 32 feet long mobile business units is depicted. At the bottom of FIG. 15, a mobile business unit is depicted including an exterior length of 40 feet.

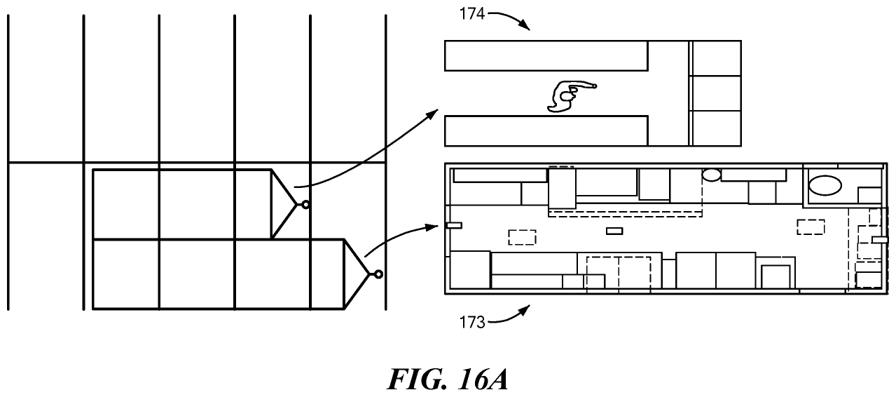

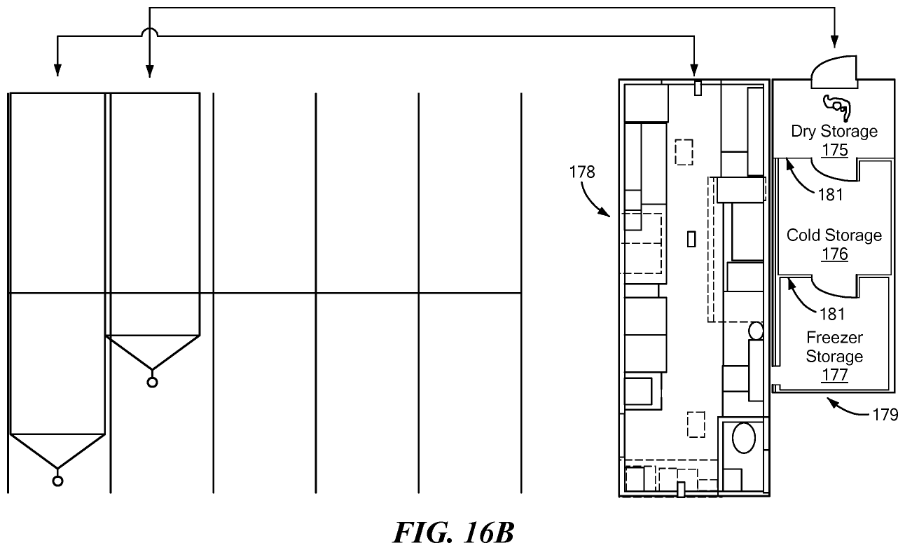

According to an aspect of this disclosure, FIG. 16A depicts an example of a side by side configuration of two mobile business units of different lengths spanning across parking spaces. A first mobile business unit 173 is configured as a mobile kitchen, and the second, shorter mobile business unit 174 is configured as a kitchen support side car. According to another aspect of this disclosure, FIG. 16B depicts an example of a side by side configuration of two mobile business units of different lengths positioned lengthwise in parking spaces. In the example shown in FIG. 16B, a first mobile business unit 178 is configured as a mobile kitchen, and the second, shorter mobile business unit 179 is configured as a kitchen support side car. The second mobile business unit 178 is depicted including a mobile a dry storage area 175 separated by a modular wall and door unit 181 from a cold storage area 176. A freezer storage area 177 is separated by a modular wall and door unit 181 from the cold storage area. By installing one or more modular wall and door units 181, smaller modularized interior spaces can be defined within a mobile business unit. By including the two mobile business units in combination, the mobile kitchens can be operated in a more self-sustaining way as they are able to store onsite more food products and other required equipment and materials.

To provide larger interior spaces, the mobile business units disclosed herein and the mobile containers can be interconnected. For example, the interior spaces of two or more mobile containers can be interconnected by utilizing a modular interconnection unit or by placing the two or more mobile containers together and removing at least a portion of two or more adjacent exterior walls of the mobile containers. In another example, two or more mobile units are placed in physical contact with at least two adjacent doors aligned to interconnect the interior spaces of the two mobile containers. The modular interconnection units described herein can be utilized to connect mobile containers, mobile business units, or both. According to some aspects, a system of mobile business units can include two or more interconnected mobile containers.

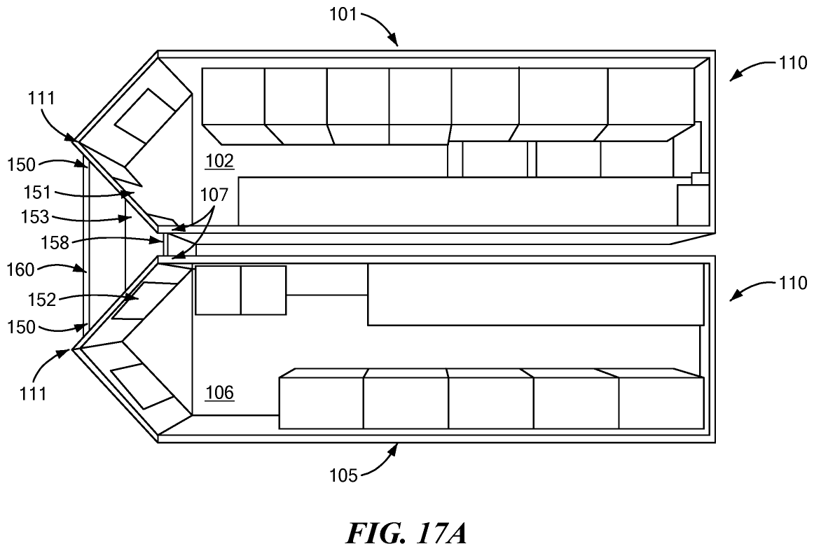

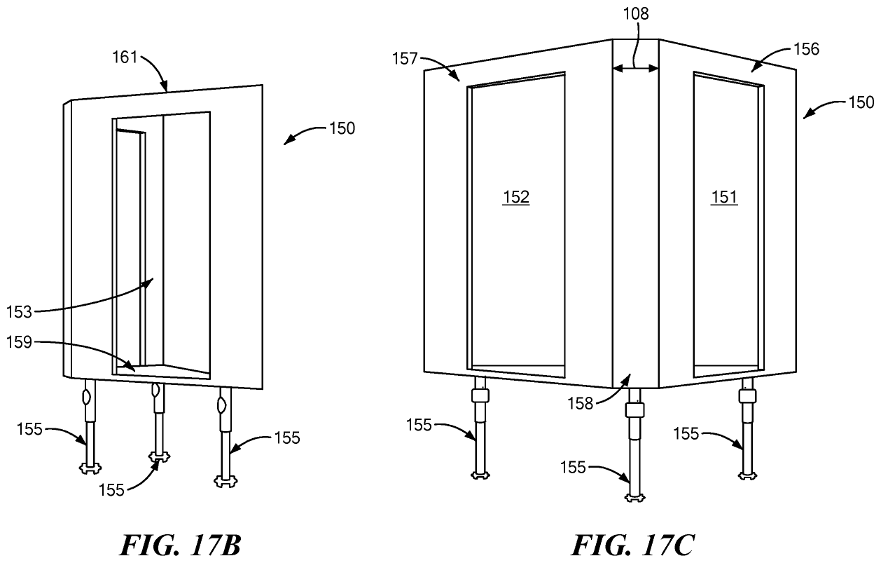

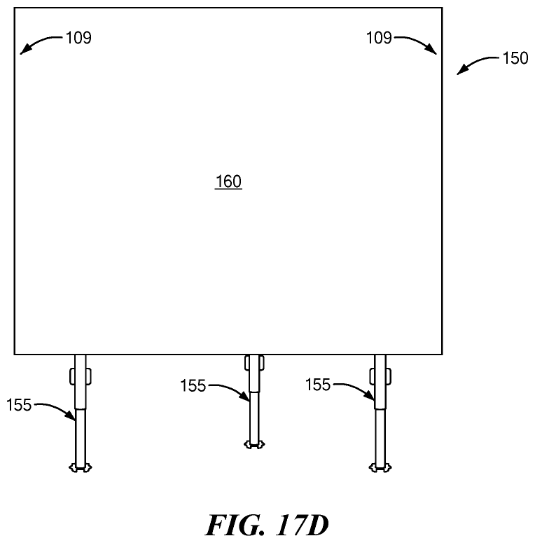

Referring now to FIG. 17A, in some embodiments, a configurable system of mobile business units 110 can include a first mobile business unit 101 disposed at a first location and a second mobile business unit 105 disposed at a second location. A modular interconnection unit 150 can physically contact an exterior surface of the first mobile business unit and physically contact an exterior surface of the second mobile business unit. The modular interconnection unit is configured to interconnect an interior 102 of the first mobile business unit to an interior 106 of the second mobile business unit. The modular interconnection unit has an interior passage 153 positioned between a first door 151 and a second door 152.

In some embodiments, the first mobile business unit and the second mobile business unit can define a first distance 107 and a second distance 111 between an exterior surface of the first mobile business unit and an exterior surface of the second mobile unit. In some embodiments, the modular interconnection unit 150 can include a back wall 158 spanning the first distance 107 and a front wall 160 spanning the second distance 111. In some embodiments, the front wall 160 spanning the second distance 111 can provide an external security wall for the configurable system of mobile business units, for example, to prevent entry from passersby.

According to some aspects of this disclosure, FIG. 17B depicts in more detail the modular interconnection unit 150 including an optional lifting system 155 for the modular interconnection unit. A roof 161 can be transparent or opaque. In some embodiments, the lifting system 155 can be, for example, substantially similar to the lifting system 26 described above with reference to FIG. 4A. The lifting system can include a piston mechanism positioned at each corner of the modular interconnection unit. For example, the lifting system can be utilized to level the interior passage 153 with the interior of a first mobile business unit and with the interior of a second mobile business unit. According to some aspects, the lifting system can be utilized to level the floor 159 of the modular interconnection unit with the floors of the mobile business units. In some embodiments, the lifting system can be utilized to connect or to disconnect the modular interconnection unit from two or more mobile business units.

According to some aspects of this disclosure, FIG. 17C depicts a rear view of the modular interconnection unit 150. A first surface 156 is configured to contact an exterior surface of the first mobile business unit 101. A second surface 157 is configured to contact an exterior surface of the second mobile business unit 105. A back wall 158 defines a width 108 that can span the first distance 107 between an exterior surface of the first mobile business unit and an exterior surface of the second mobile unit. FIG. 17D shows a front view of the modular interconnection unit 150 in accordance with various embodiments. The front wall 160 of the modular interconnection unit defines a width 109 that can span the second distance 111 between an exterior surface of the first mobile business unit and an exterior surface of the second mobile unit. In some embodiments, the height of the modular interconnection unit can be equal or nearly equal to the heights of the first mobile business unit and the second mobile business unit. In some embodiments, the height of the modular interconnection unit can extend up to the height of two or more stacked mobile containers.

The shape of the modular interconnection unit depicted in FIG. 17A is operative to contact an exterior surface of a first mobile business and a second mobile business unit. However, it will be apparent in view of this disclosure that, the shape of the modular interconnection unit can changed to accommodate, for example, side to side interconnection between a first mobile business unit and a second mobile business unit, end to end interconnection, front to side interconnection, back to side interconnection, stacked interconnection, or a combination thereof, depending the first location of the first business unit and the second location of the second mobile business unit. In some embodiments, the modular interconnection unit can include more than two doors, for example, for interconnecting more than two mobile business units.

In some embodiments, the modular interconnection unit 150 can interconnect an interior of first mobile container at a ground level to an interior of a second mobile container at a ground level, and a lifting system 155 is not required.

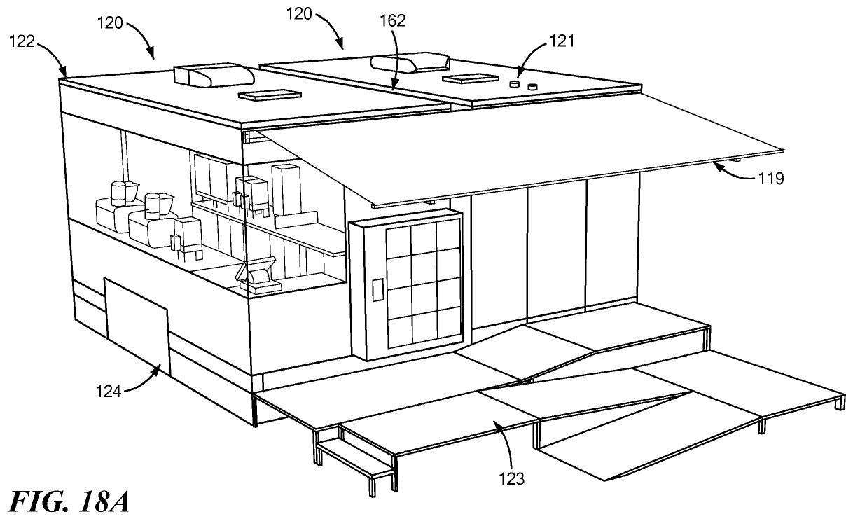

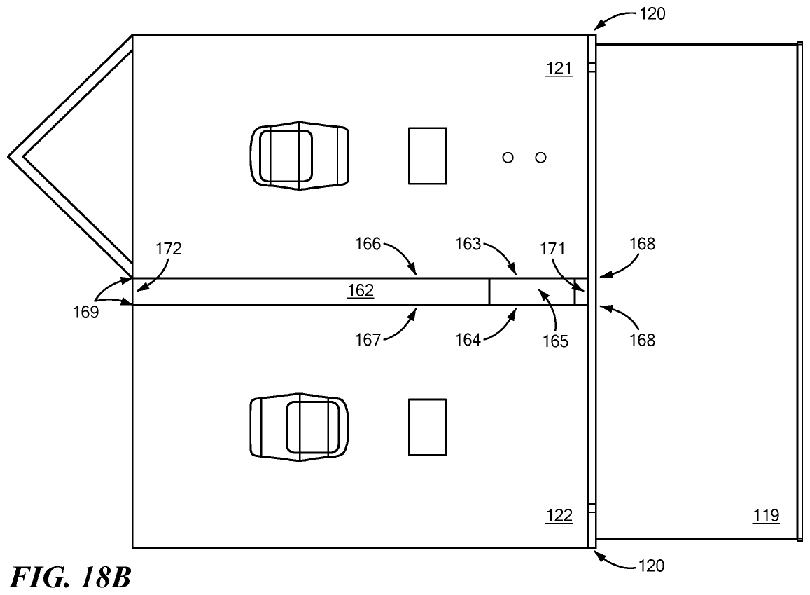

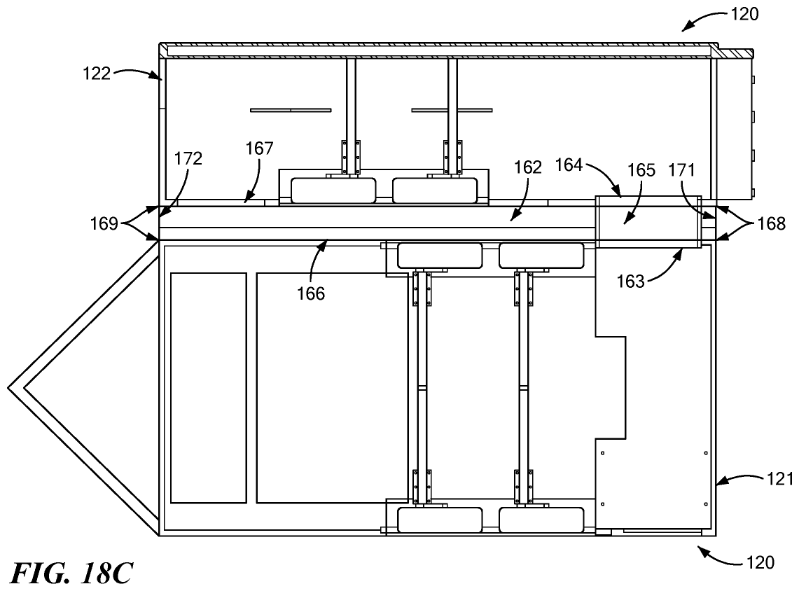

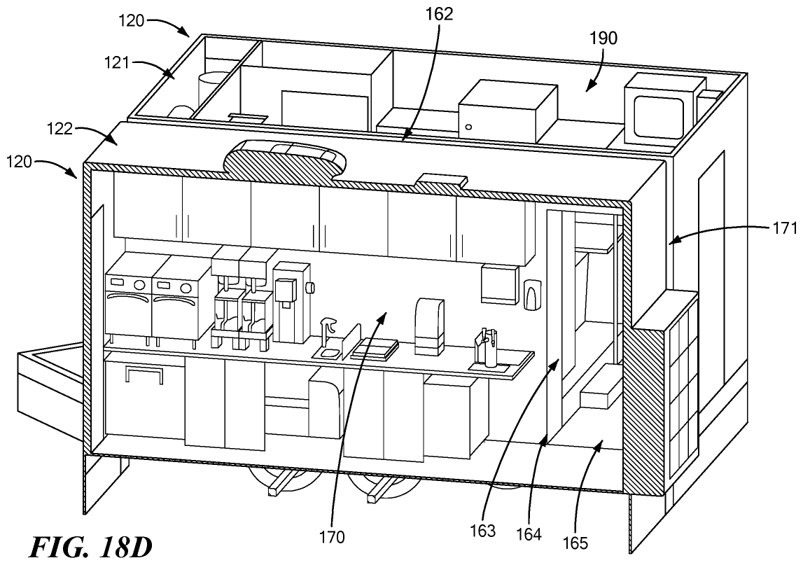

Referring now to FIG. 18A, in some embodiments, a configurable system of mobile business units 120 can include a first mobile business unit 121 disposed at a first location and a second mobile business unit 122 disposed at a second location. A modular interconnection unit 162 can physically contact an exterior surface of the first mobile business unit and physically contact an exterior surface of the second mobile business unit. The configurable system of mobile business units 120 can include a variety of external infrastructures, for example, an accessibility ramp 123, an awning 119, and side covers 124.

According to some aspects of this disclosure, FIG. 18B and FIG. 18C depict in more detail the modular interconnection unit 162 including an interior passage or region 165 positioned between a first door or opening 163 and a second door or opening 164. Referring to FIG. 18B and to FIG. 18C, the modular interconnection unit has a first surface 166 configured to contact an exterior surface of the first mobile business unit 121. A second surface 167 is configured to contact an exterior surface of the second mobile business unit 122. In some embodiments, the first mobile business unit and the second mobile business unit can define a first distance 168 and a second distance 169 between an exterior surface of the first mobile business unit and an exterior surface of the second mobile unit. A front wall 171 of the modular interconnection unit defines a width that can span the first distance 168 between an exterior surface of the first mobile business unit and an exterior surface of the second mobile unit. A back wall 172 defines a width that can span the second distance 169 between an exterior surface of the first mobile business unit and an exterior surface of the second mobile unit.

According to some aspects of this disclosure, FIG. 18D depicts a perspective and interior view of the configurable system of mobile business units 120 including the modular interconnection unit 162. The modular interconnection unit is configured to interconnect an interior 190 of the first mobile business unit 121 to an interior 170 of the second mobile business unit 122. The modular interconnection unit has an interior passage 165 positioned between a first door 163 and a second door 164. A front wall 171 of the modular interconnection unit spans a first distance 168, depicted in FIG. 18B and in FIG. 18C, between an exterior surface of the first mobile business unit and an exterior surface of the second mobile unit.

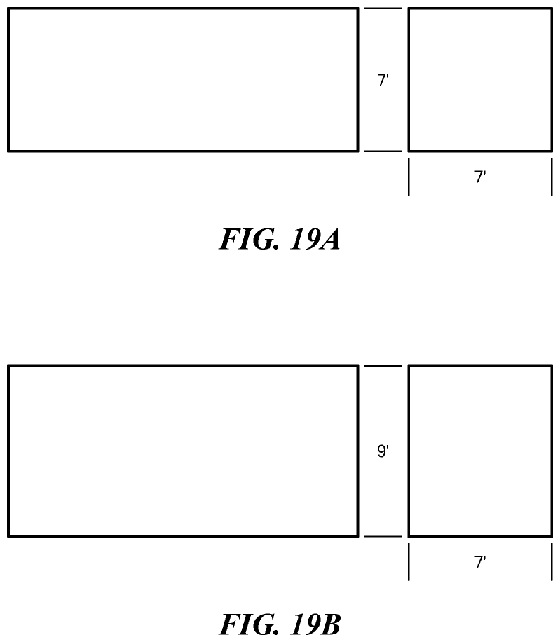

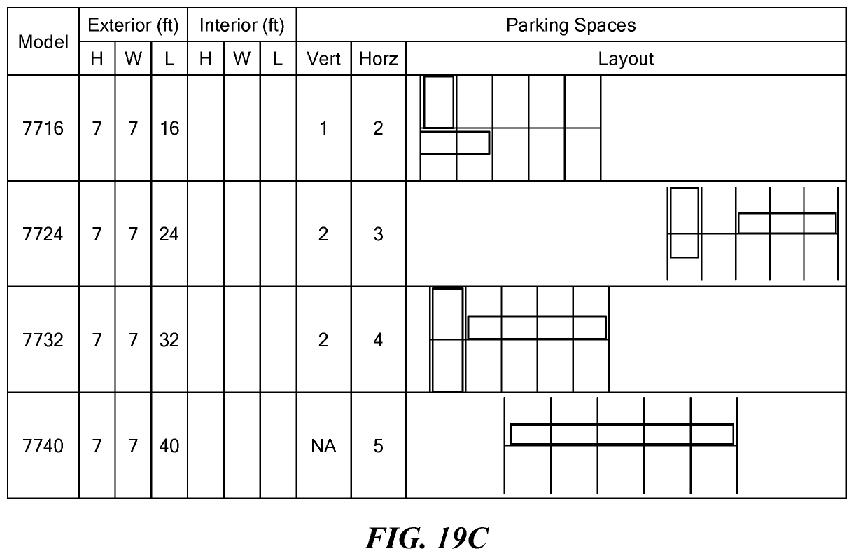

In some embodiments, based on the compact size (e.g., about 8 feet) of compact parking spaces, mobile business units can be configured as non-trailered containers and can be provided in standard sizes planned for parking spaces. The non-trailered container may be transported by flat bed or containerized trucks and dropped off at the desired site. According to some aspects of this disclosure, FIG. 19A shows a side view and a front view of a mobile container with example width and height of 7 feet in accordance with various embodiments. FIG. 19B shows a side view and a front view of a mobile container with example width of 7 feet and height of 9 feet in accordance with various embodiments. The 7 feet width depicted in FIG. 19A and FIG. 19B is depicted, according to some aspects of this disclosure, in FIG. 19C, which shows example configurations and layouts of mobile containers in parking spaces. However, it will be apparent in view of this disclosure that, depending on the physical shape of the parking facility, the location of the parking facility, the age of the parking facility, the company operating the parking facility, intended vehicle type, combinations thereof, or any other factors, parking spaces, mobile containers, and mobile business units may be provided with any other suitable combination of dimensions.

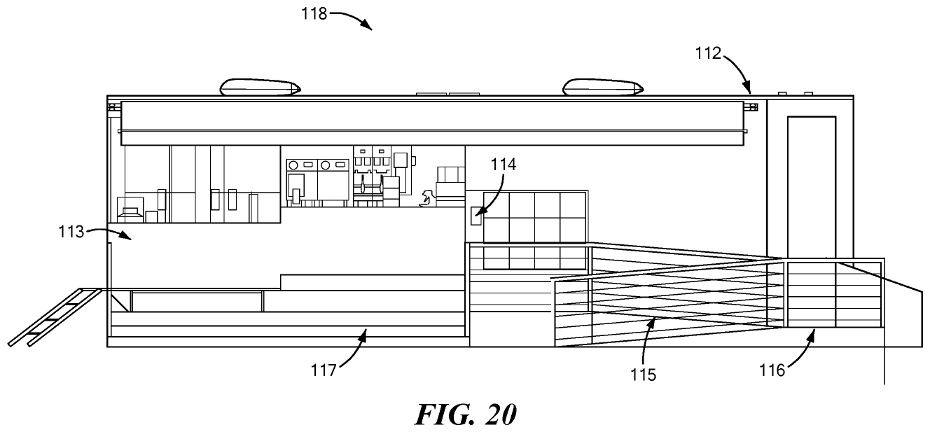

According to some aspects, when a modular interconnection unit is utilized, the interconnected mobile business units and/or mobile containers can be different lengths. When the mobile business units are interconnected, access to the interior spaces of two or more mobile business can be provided at any side of the interconnected mobile business units. According to some aspects of this disclosure, FIG. 20 depicts a side view of a configurable system of mobile business units 118 including a longer first mobile business unit 112 interconnected with a shorter second mobile business unit 113 and an accessibility ramp 116 leading to an entry 114 on an end of the shorter mobile business unit. The configurable system of mobile business units also includes side coverings 117 and a guard rail 115.

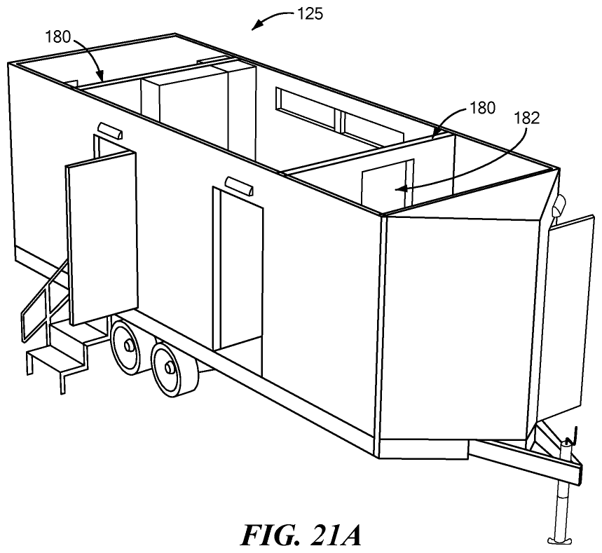

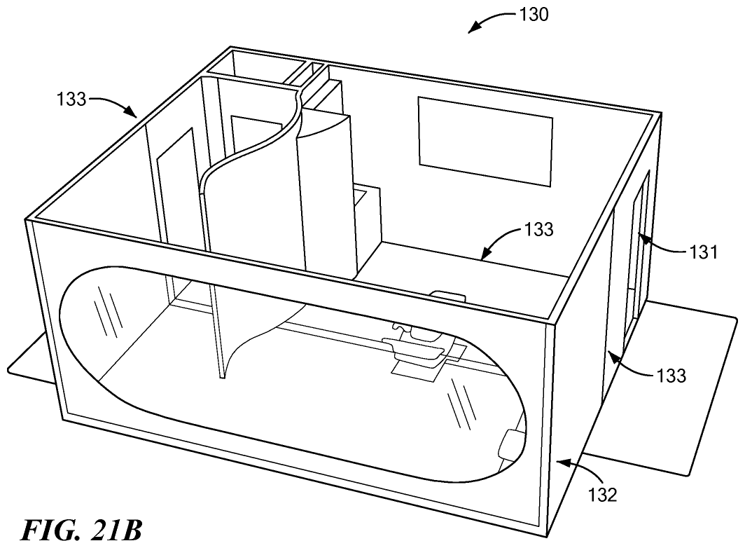

By utilizing internal modular walls, the internal space of a mobile business unit can be modularized, for example, for private meeting rooms, offices, or for patient examination rooms. According to some aspects of this disclosure, FIG. 21A shows a perspective view of mobile business unit configured to provide a mobile healthcare unit 125. One or more modularized internal walls 180, each with an optional door 182 can, for example, provide separate rooms for privacy.

Regardless of configuration, in some applications two or more mobile business units 100 or mobile containers 400, depicted in FIG. 1, can be positioned proximately to one another in stacked, side by side, perpendicular, or end to end configurations to provide larger facilities to meet business needs. According to some aspects, one or more external walls can be removed. For example, FIG. 21B shows a perspective view of a system of mobile containers 130 combined side by side to provide mobile healthcare. At a central position 133, an exterior wall has been removed from the first mobile container 131, and an exterior wall has been removed from the second mobile container 132 to interconnect an interior of the first mobile container with an interior of the second mobile container.

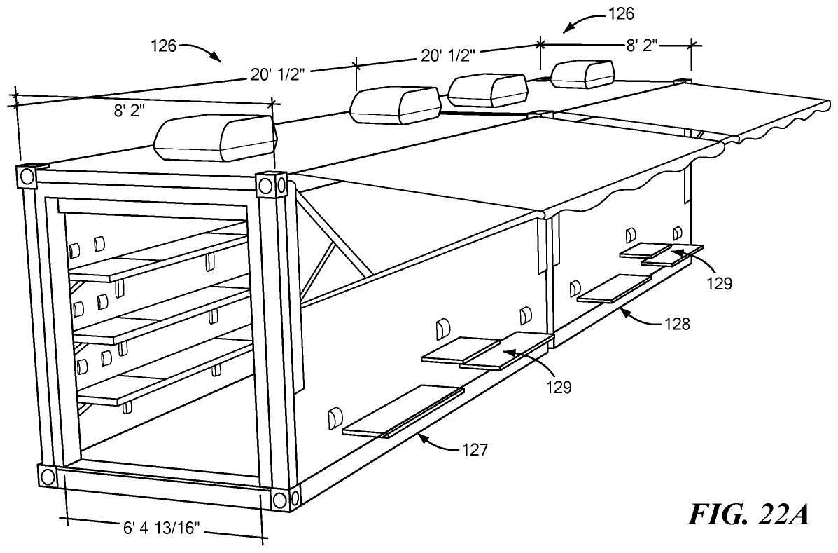

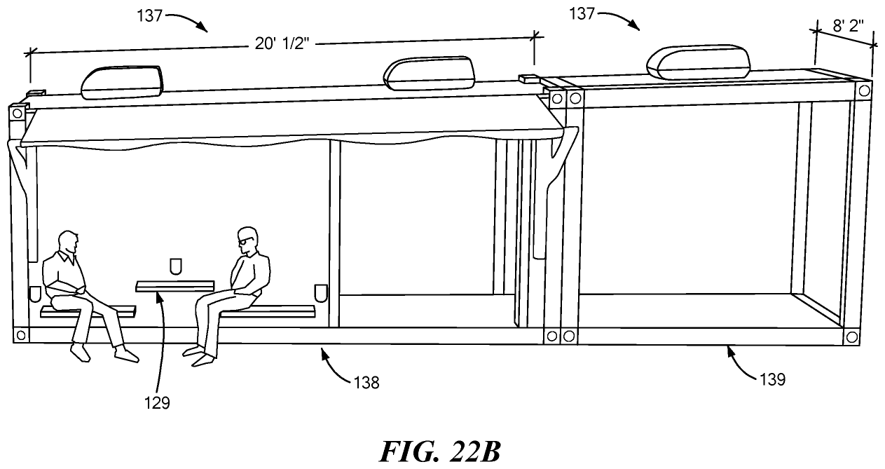

Embodiments of a mobile business unit including a mobile container and a system of mobile business units are depicted as mobile or ghost kitchens, as mobile health care and testing units, grocery-to-go units, and mobile offices herein. However, the mobile business unit including a mobile container and a system of mobile business units can be applied, for example, anytime mobile space is required. According to an aspect of this disclosure, a mobile space is depicted in FIG. 22A with a configurable system of mobile business units 126 including two mobile containers with a first mobile container 127 positioned end to end with a second mobile container 128 to provide a proximity space. A plurality of modular benches 129 affixed to an exterior wall of the system 126 can provide exterior seating. FIG. 22B depicts a side view of a configurable system of mobile business units 137 including a first mobile container 138 positioned end to end with a second mobile container 139 to provide modularized benches 129 and proximity space.

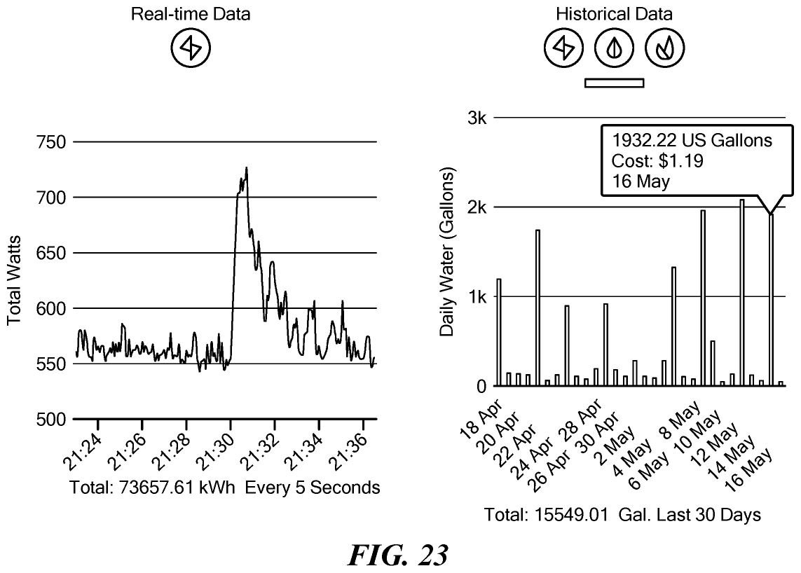

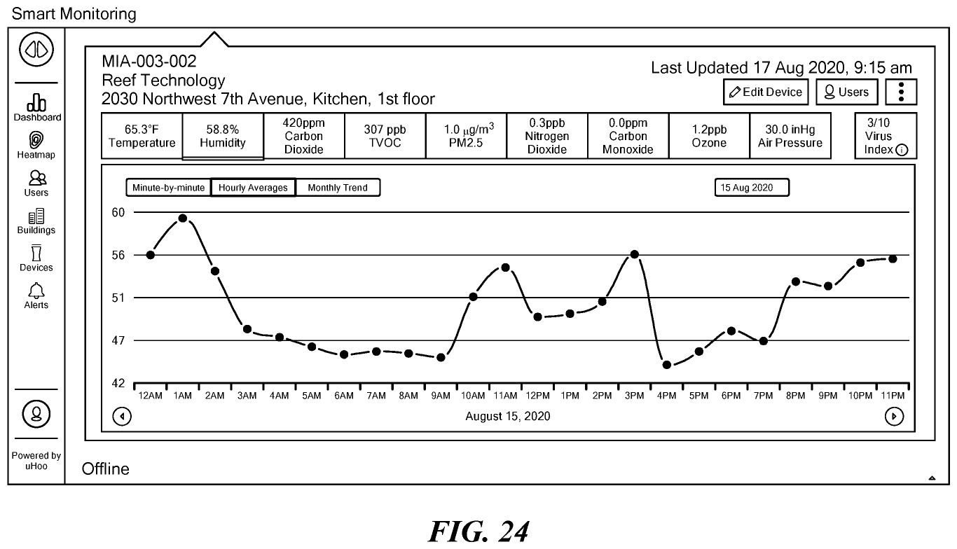

Integration with the internet can be accomplished, for example, utilizing various equipment and software that can be provided with the mobile containers herein. Each mobile container can include, for example, sensors (e.g., temperature, humidity, air quality, cameras, GPS, and proximity sensors) integrated with the internet. Configurable smart data can be acquired and integrated utilizing business unit equipment and software. FIG. 23 illustrates an example of smart phone monitoring of real-time power usage (left) and historical water usage (right) for a mobile container in accordance with various embodiments. FIG. 24 illustrates an example of smart air quality monitoring for a mobile container in accordance with various embodiments. An example of the hourly humidity is shown in FIG. 24 along with access buttons to the virus index, air pressure, ozone levels, carbon monoxide levels, nitrogen dioxide levels, temperature, carbon dioxide levels, total volatile organic compounds (TVOC), and particulate matter (PM2.5).

While the disclosure has been described in terms of exemplary embodiments, those skilled in the art will recognize that the disclosure can be practiced with modifications in the spirit and scope of the features or of the appended claims. These examples are merely illustrative and are not meant to be an exhaustive list of all possible designs, embodiments, applications or modifications of the disclosure.

What is claimed is:

1. A reconfigurable mobile business unit comprising:
a main frame having an interior floor surface;
a container frame having a plurality of interior wall surfaces mounted on and along a circumference of the interior floor surface of the main frame, each of the plurality of wall surfaces extending substantially perpendicular from the interior floor surface; the container frame also having an interior ceiling surface mounted on the plurality of interior wall surfaces and being substantially parallel to the interior floor surface; wherein the interior floor surface, the interior wall surfaces, and the interior ceiling surface together define an interior volume of the mobile business unit;
a plurality of equipment locations positioned at regular intervals about the circumference of the interior floor surface of the main frame, each of the equipment locations having a utility bundle installed in one of an interior wall surface or the interior floor surface and being accessible in the interior volume of the mobile business unit to enable installation of a piece of business unit equipment at any one of the plurality of equipment locations.

2. The reconfigurable mobile business unit of claim 1 wherein each utility bundle includes at least two utilities selected from the following utility types: electrical, water, drainage, propane, or gas.

3. The reconfigurable mobile business unit of claim 1 wherein the mobile business unit is configured as one or more of the following: a mobile kitchen, a mobile health care unit, a classroom, an office space, a disaster relief facility, a fabrication unit, a pharmacy, a grocery-to-go unit, a mobile repair garage, a broadcasting center, or combinations thereof.

4. The reconfigurable mobile business unit of claim 1 wherein the mobile business unit is configured as a kitchen and one or more of the following equipment types may be installed at the plurality of equipment locations: a refrigerator, a microwave, an oven, a freezer, an electric fryer, a stove top, an electric griddle, an induction stove, an extraction hood, a dishwasher, a hand sink, a mop sink, a water pump, a fire suppression system, an A/C unit, a heat and condensation pump.

5. The reconfigurable mobile business unit of claim 1 wherein the mobile business unit is configured for medical use and one or more of the following equipment types may be installed at the plurality of equipment locations: a patient data terminal, a surgery bed, an autoclave, an instrument table, an x-ray machine, a triage/intake station, and a utility sink.

6. The reconfigurable mobile business unit of claim 1 wherein the mobile business unit is configured as an office and one or more of the following equipment types may be installed at the plurality of equipment locations: a desk, a filing cabinet, partitions or cubicles, private meeting rooms, a drink/coffee machine, and a printer.

7. The reconfigurable mobile business unit of claim 1 wherein the mobile business unit is configured as grocery store and one or more of the following equipment types may be installed at the plurality of equipment locations: a refrigerator unit, a freezer unit, water distribution for a produce display unit with water distribution, a scale, a scanner, and a check out station.

8. The reconfigurable mobile business unit of claim 1 further including one or more sensors to monitor one or more of the following: air quality, power usage, utilities status and usage, temperature, smoke, and carbon monoxide.

9. A configurable system of mobile business units for deployment at a site, comprising:
A first mobile business unit disposed at a first location at the site;
A second mobile business unit disposed at a second location at the site; and
A modular interconnection unit physically in contact with an exterior surface of the first mobile business unit and physically in contact with an exterior surface of the second mobile business unit; the modular interconnection unit configured to interconnect an interior of the first mobile business unit to an interior of the second mobile business unit.

10. The configurable system of claim 9 wherein the modular interconnection unit includes an interior region, a first opening in communication with the first mobile business unit and the interior region of the modular interconnection unit, and a second opening in communication with the second mobile business unit and the interior region of the modular interconnection unit.

11. The configurable system of claim 9 wherein the modular interconnection is one of triangular or rectangular in shape.

12. The configurable system of claim 9 wherein the first mobile business unit and the second mobile business unit include a lifting system to elevate the first and second mobile business units; and where in the modular interconnection unit includes a lifting system to elevate the modular interconnection unit to be aligned with the first and second mobile business units.

13. The configurable system of claim 9 wherein each lifting system includes a plurality of piston mechanisms.

14. The configurable system of mobile business units of claim 9, wherein each of the first mobile business and the second mobile business unit include:
a main frame having an interior floor surface;
a container frame having a plurality of interior wall surfaces mounted on and along a circumference of the interior floor surface of the main frame, each of the plurality of wall surfaces extending substantially perpendicular from the interior floor surface; the container frame also having an interior ceiling surface mounted on the plurality of interior wall surfaces and being substantially parallel to the interior floor surface; wherein the interior floor surface, the interior wall surfaces, and the interior ceiling surface together define an interior volume of the mobile business unit;
a plurality of equipment locations positioned at regular intervals about the circumference of the interior floor surface of the main frame, each of the equipment locations having a utility bundle installed in one of an interior wall surface or the interior floor surface and being accessible in the interior volume of the mobile business unit; each utility bundle including at least electrical, water, and drainage utilities to enable installation of a piece of business unit equipment at any one of the plurality of equipment locations.

15. The configurable system of mobile business units of claim 9, wherein each of the first mobile business and the second mobile business unit may be configured as one of the following: a mobile kitchen, a mobile health care unit, a classroom, an office space, a disaster relief facility, a fabrication unit, a pharmacy, a grocery-to-go unit, a mobile repair garage, a broadcasting center, or combinations thereof.
